(19) United States
(12) Patent Application Publication
(10) Pub. No.: US 2026/0355761 A1
(43) Pub. Date: Nov. 12, 2026

(54) SOLVENT DOSING AND DOSE PISTON FOR A SPRAY APPLICATOR

(71) Applicant: Graco Minnesota Inc., Minneapolis, MN (US)

(72) Inventors: Christopher J. Pellin, Victoria, MN (US); Joseph E. Tix, Hastings, MN (US); John R. Ingebrand, New Prague, MN (US)

(21) Appl. No.: 19/125,157

(22) PCT Filed: Oct. 24, 2023
(86) PCT No.: PCT/US2023/035801

§ 371 Date: Apr. 28, 2025

Related U.S. Application Data
(60) Provisional application No. 63/422,505, filed on Nov. 4, 2022.

(51) Int. Cl. B05B 7/04; B05B 1/30; B05B 7/12; B05B 7/24; B05B 12/00; B05B 15/55

(52) U.S. Cl. CPC B05B 7/0408; B05B 1/3026; B05B 7/1209; B05B 7/2424; B05B 12/002; B05B 15/557

(57) ABSTRACT

A spray applicator is operable in a spray state, during which the applicator emits a plural component material formed within a mix chamber of the spray application, and a purge state, during which the spray applicator emits compressed air from the mix chamber as purge air. A control piston controls actuation of the spray apparatus between the spray state and the purge state. A dose piston is configured to dose volumes of solvent into a purge air flow for carrying to the mix chamber. The dose piston rides within the control piston and moves in an opposite axial direction from the control piston.

### CROSS-REFERENCE TO RELATED APPLICATION(S)

This application claims priority to U.S. Provisional Application No. 63/422,505 filed Nov. 4, 2022 and entitled “SOLVENT DOSING AND DOSE PISTON FOR A SPRAY APPLICATOR,” the disclosure of which is hereby incorporated by reference in its entirety.

### BACKGROUND

This disclosure relates generally to fluid sprayers. More specifically, this disclosure relates to plural component spray applicators.

Plural component sprayers are configured to generate and apply coatings to substrates, such as spray foam insulation and elastomer coatings. Spray foam insulation is applied to substrates to provide thermal insulation from the environment. Elastomer coatings can be applied to a substrate to protect a surface, an example of which is a spray-in truck bed liner. For plural component spraying, two or more base components are mixed within the spray applicator causing a chemical reaction that forms the plural component material from the base component materials. Plural component sprayers can emit purge air through the mixing area and spray orifice to clear the fast-setting plural component material from withing the sprayer to prevent clogging.

### SUMMARY

According to an aspect of the disclosure, a spray apparatus includes a sprayer body; a mix chamber supported by the sprayer body; a purge air pathway extending to an inlet port of the mix chamber to provide purge air to the mix chamber; a control piston at least partially disposed in the sprayer body; and a dose piston at least partially disposed within the sprayer body. The control piston is actuatable along an axis between a first control position associated with a purge mode in which the control piston causes component flowpaths to be fluidly disconnected from the mix chamber; and a second control position associated with a spray mode in which the control piston causes the component flowpaths to fluidly connect to the mix chamber. The dose piston is actuatable between a first dose position associated with emission of purge air from the mix chamber, the dose piston configured to provide solvent to the purge air pathway when in the second dose position; and a second dose position associated with emission of the plural component material from the mix chamber, the dose piston fluidly connected to a solvent passage when in the reset position. The control piston shifts in a first axial direction along the axis from the first control position to the second control position, the control piston shifts in a second axial direction opposite the first axial direction from the second control position to the first control position, the dose piston shifts in the first axial direction from the second dose position to the first dose position, and the dose piston shifts in the second axial direction from the first dose position to the second dose position.

According to another aspect of the disclosure, a spray apparatus includes a control piston operatively connected to a spray valve to actuate the spray apparatus between a spray state and a purge state, wherein spray material is emitted from a spray orifice with the spray apparatus in the spray state and purge air is emitted from the spray orifice with the spray apparatus in the purge state; and a dose piston carried by the control piston and actuatable between a first dose position and a second dose position, wherein the dose piston is configured to pick up a volume of solvent in the second dose position and the dose piston is configured to dose the volume of solvent into the purge air in the first dose position; wherein the dose piston moves in an opposite direction from the spray piston along an actuation axis as the spray apparatus transitions between the spray state and the purge state.

According to yet another aspect of the disclosure, a method of spraying includes placing a spray applicator in a spray mode, wherein a first material pathway and a second material pathway are fluidly connected to a mix chamber with the spray applicator in the spray mode; emitting, by the spray applicator, a plural component material formed within the mix chamber by a first base component material provided to the mix chamber through the first material pathway and a second base component material provided to the mix chamber through the second material pathway; actuating a control piston in a first axial direction along an actuation axis to fluidly disconnect the first material pathway and the second material pathway from the mix chamber and to fluidly connect a purge air pathway with the mix chamber, thereby placing the spray applicator in a purge mode; and actuating a dose piston in a second axial direction along the actuation axis to entrain a dose of solvent picked up from a location within the control piston into a purge air flow flowing axially through the dose piston and the control piston to be carried to the mix chamber by the purge air flow, the second axial direction opposite the first axial direction.

According to yet another aspect of the disclosure, a dose piston for dosing solvent into a purge air pathway of a plural component sprayer, the dose piston includes a dose piston head; a dose piston shaft extending along an axis from the dose piston head; and a purge air bore formed within the dose piston head and the dose piston shaft and configured to route purge air from a purge bore inlet formed in the dose piston head to a purge bore outlet formed in the dose piston shaft, wherein the purge bore outlet is formed in a radially exterior surface of the dose piston shaft.

### BRIEF DESCRIPTION OF THE DRAWINGS

FIG. 1A is a schematic block diagram of a spray system.

FIG. 1B is a schematic block diagram of the spray system of FIG. 1A showing flowpaths through a spray applicator.

FIG. 2A is an isometric view of a spray applicator.

FIG. 2B is an isometric exploded view of the spray applicator.

FIG. 3A is an enlarged cross-sectional view of a portion of a spray applicator showing the spray applicator in a purge state.

FIG. 3B is an enlarged cross-sectional view of the portion of the spray applicator shown in FIG. 3A showing the spray applicator in a spray state.

FIG. 4A is an enlarged cross-sectional view of a portion of a spray applicator taken along line 4-4 in FIG. 2A, showing the spray application in a purge state.

FIG. 4B is an enlarged cross-sectional view of the portion of the spray applicator shown in FIG. 4A, showing the spray application in a first transition state.

FIG. 4C is an enlarged cross-sectional view of the portion of the spray applicator shown in FIG. 4A, showing the spray application in a spray state.

FIG. 5A is an enlarged cross-sectional view of a portion of a spray applicator taken along line 5-5 in FIG. 2A, showing the spray application in the spray state.

FIG. 5B is an enlarged cross-sectional view of the portion of the spray applicator shown in FIG. 5A, showing the spray application in a second transition state.

FIG. 5C is an enlarged cross-sectional view of the portion of the spray applicator shown in FIG. 5A, showing the spray application in the purge state.

FIG. 6 is an enlarged, isometric cross-sectional taken along line 4-4 in FIG. 2A.

FIG. 7 is a cross-sectional view of a dose piston.

### DETAILED DESCRIPTION

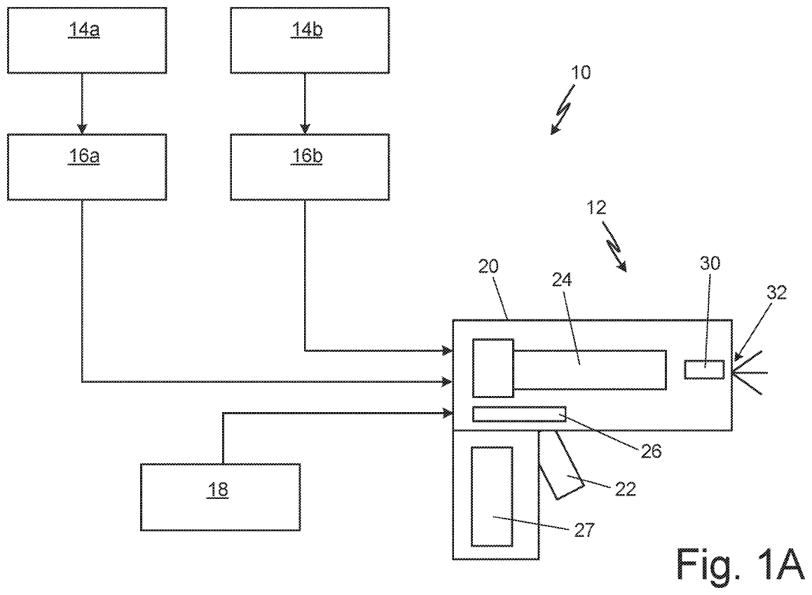

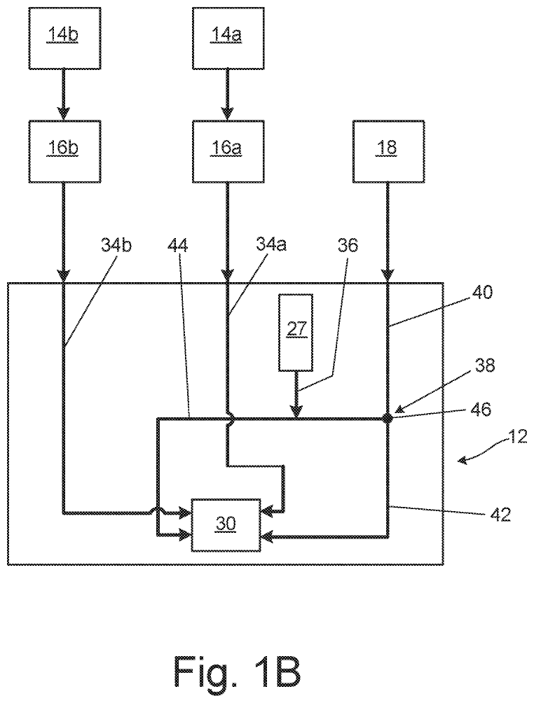

This disclosure is directed to a spray applicator for applying plural component materials to a substrate. The spray applicator includes a mix chamber configured to receive separate flows of different first and second base component materials that mix together to form the plural component material. The spray applicator emits the combined plural component material from the mix chamber during a spray mode and emits purge air from the mix chamber during a purge mode. First and second purge air flows are provided to the mix chamber to purge material residue from the mix chamber. Solvent is injected the purge air flow upstream of the mix chamber to be carried to mix chamber by the purge air. The solvent assists in clearing residue from the plural component material out of and off of the mix chamber. A dosing piston controls dosing of the solvent into purge air flow. The dosing piston is retained by a drive piston that controls movement of the valve members, which valve members control spraying by the sprayer. The dosing piston is disconnected from the driving piston such that the dosing piston can move relative to the driving piston. FIG. 1A is a schematic block diagram of spray system 10. FIG. 1B is a schematic block diagram of spray system 10 showing flowpaths through spray applicator 12. FIGS. 1A and 1B will be discussed together. Spray system 10 includes spray applicator 12, material supplies 14a and 14b, pumps 16a and 16b, and air supply 18. Spray applicator 12 includes body 20, trigger 22, spray control assembly 24, control valve 26, solvent reservoir 27, mix chamber 30, and spray orifice 32. As shown in FIG. 1B, spray applicator 12 further includes material pathway 34a, material pathway 34b, solvent pathway 36, and air pathway 38. Air pathway 38 includes common passage 40, first passage 42, and second passage 44. Spray system 10 is a system configured to generate a material spray and apply the material spray to a substrate. In some examples, spray system 10 is configured to combine two or more base component materials to generate a plural component material for application to the substrate. In some examples, spray system 10 is configured to generate and apply spray foam insulation or an elastomer coating onto the substrate, among other spray options.

Material supplies 14a, 14b store supplies of base component materials prior to spraying. A plural component material, such as the spray foam or elastomer coating, is formed by mixing the base component materials within mix chamber 30. Spray foam insulation is discussed herein as an exemplar, but it is understood that the disclosure is not limited to spray foam applications. For example, fluid supply 14a can store a first base component material, such as a resin, and fluid supply 14b can store a second base component material, such as a catalyst. In some examples, the first one of the base component materials can be polyol resin and the second one of the base component materials can be isocyanate. The first and second base component materials combine at spray applicator 12 (e.g., within mix chamber 30) and are ejected from spray applicator 12 as a spray of the plural component material. Spray applicator 12 generates the spray of the plural component material and applies the plural component material to the substrate. Spray applicator 12 can alternatively be referred to as a mixer, mixing manifold, dispenser, and/or spray gun, among other options.

Pump 16a is configured to draw the first base component material from fluid supply 14a and transfer the first base component material downstream to spray applicator 12. Pump 16b is configured to draw the second base component material from fluid supply 14b and transfer the second base component material downstream to spray applicator 12. Pumps 16a, 16b can be controlled by a system controller (not shown). The first base component material flows through material pathway 34a in spray applicator 12. The second base component material flows through material pathway 34b in spray applicator 12. The first base component material is fluidly isolated from the second base component materials at locations upstream of mix chamber 30.

Air supply 18 is connected to spray applicator 12 and configured to provide a flow of compressed air to spray applicator 12. Air supply 18 can be of any suitable configuration for providing the compressed air to spray applicator 12. For example, air supply 18 can be a compressor, a pressurized tank, or of any other configuration suitable for providing a pressurized pneumatic flow. Air supply 18 provides the pressurized air to the pneumatic pathway through spray applicator 12, which pneumatic pathway is at least partially formed by air pathway 38 through spray applicator 12.

The pressurized air is initially provided to common passage 40. First passage 42 and second passage 44 are configured to provide individual flows of pressurized purge air to mix chamber 30. First passage 42 is configured to provide a first portion of the pressurized purge air to mix chamber 30 through the same port in mix chamber 30 that material pathway 34a provides the first base component material. Second passage 44 is configured to provide second portion of the pressurized purge air to mix chamber 30 through the same port in mix chamber 30 that material pathway 34b provides the second base component material. The purge air flows through mix chamber 30 to pick up material within mix chamber 30 and blow the material out of mix chamber 30. The purge air thereby prevents undesirable curing of material within mix chamber 30.

Spray applicator 12 is configured to generate and apply the spray of the plural component material. Body 20 of spray applicator 12 supports other components of spray applicator 12. Control assembly 24 is disposed at least partially within spray applicator 12. Control assembly 24 is configured to control whether the first and second base component materials flow to mix chamber 30 or whether the first and second purge air flows flow to mix chamber 30. Control assembly 24 allows the first and second component materials to flow to mix chamber 30 with spray applicator 12 in a spray mode. Control assembly 24 allows the purge air to flow to mix chamber 30 with spray applicator 12 in a purge mode. Control valve 26 is disposed at least partially within spray applicator 12. Control valve 26 is operatively connected to control assembly 24 to actuate control assembly 24 between the spray and purge modes, as discussed in more detail below. Control valve 26 is configured to direct pressurized air to control actuation of pistons of the control assembly 24, as discussed in more detail below.

Mix chamber 30 is disposed at the downstream ends of material pathways 34a, 34b, first passage 42, and second passage 44. Spray orifice 32 is formed in mix chamber 30. With spray applicator 12 in the spray mode, mix chamber 30 receives the first and second base component materials from material pathways 34a, 34b, the base materials interact in a bore of mix chamber 30 to form the plural component material within mix chamber 30, and a spray of the plural component material is emitted through spray orifice 32. With spray applicator 12 in the purge mode, mix chamber 30 receives the first and second purge air flows and emits purge air through spray orifice 32. The purge air is configured to clear residue from within mix chamber 30 to prevent the plural component material from curing within mix chamber 30 and prevent clogging of spray orifice 32.

Trigger 22 is attached to spray applicator 12 and configured to control the spraying by spray applicator 12. Trigger 22 is configured to be actuated to transition spray applicator 12 between the spray mode, during which the plural component material is formed and emitted, and the purge mode, during which the purge air is emitted. The user can actuate trigger 22 to cause spray valve 24 to shift to the spray state, thereby fluidly connecting material pathways 34a, 34b with mix chamber 30 and fluidly disconnecting first passage 42 and second passage 44 from mix chamber 30. The base component materials combine within mix chamber 30 to form the plural component material that is emitted from spray orifice 32.

The user releases trigger 22 to cause spray valve 24 to shift to the purge state, thereby fluidly disconnecting material pathways 34a, 34b from mix chamber 30 and fluidly connecting first passage 42 and second passage 44 with mix chamber 30. The purge air portions flow through first passage 42 and second passage 44 into mix chamber 30 and are emitted from spray orifice 32. It is understood that trigger 22 can be of any configuration suitable for activating and deactivating the spraying by spray applicator 12. While spray applicator 12 is described as a manual spray gun configured to be held and manipulated by a user, it is understood that other examples of spray applicator 12 can be automatic such that spray applicator 12 does not include a manually actuated trigger 22 or a handle.

Solvent reservoir 27 stores a supply of solvent that is provided to the mix chamber 30 intermittently throughout operation. The solvent assists in clearing mix chamber 30 with spray applicator 12 in the purge mode. For example, the solvent can slow the reaction process to inhibit curing and can dissolve uncured plural component material. Solvent reservoir 27 can be disposed within spray applicator 12, such as within a handle of spray applicator 12. Solvent reservoir 27 contains the solvent. In some examples, solvent reservoir 27 can be formed as a cartridge that can be removed and replaced as a single unit. Solvent pathway 36 extends downstream from solvent reservoir 27 to air pathway 38. In the example shown, solvent pathway 36 extends to second passage 44. The solvent pathway 36 can be considered to extend to mix chamber 30 such that a portion of second passage 44 defines both air pathway 38 and solvent pathway 36.

In some examples, spray applicator 12 is configured such that solvent is provided to mix chamber 30 via second passage 44 but not via first passage 42. Providing the solvent through only second passage 44 prevents mixing of the solvent with the base component material provided through material pathway 34a at locations upstream of mix chamber 30. For example, material pathway 34b can be configured to provide the resin base component material to mix chamber 30 while material pathway 34a can be configured to provide the isocyanate base component material. Isocyanate is moisture-sensitive and can cure when exposed to a liquid, such as the solvent. The cured isocyanate forms crystals that can cause scoring or other damage to soft seals and clogging of pathways through spray applicator 12. Flowing the solvent into mix chamber 30 through the same port as the resin prevents mixing of solvent and isocyanate within spray applicator 12 at locations upstream of mix chamber 30. It is understood, however, that not all examples are limited to supplying solvent by a single air passage. For example, some examples of spray applicator 12 can include a solvent pathway 36 that intersects with the air pathway 38 at a location upstream of an intersection between first passage 42 and second passage 44 such that the solvent is carried through both first passage 42 and second passage 44.

During operation, the user actuates trigger 22 to transition spray applicator 12 between the spray and purge modes. Trigger 22 is operably associated with control valve 26 to cause spraying by spray applicator 12 by actuating control valve 26. In some examples, control valve 26 directs compressed air from air supply 18 to control assembly 24 to drive control assembly 24 between positions associated with the spray mode and the purge mode. For example, control valve 26 can direct the compressed air through a first internal pathway within spray applicator 12 to displace a control piston 84 of control assembly 24 and displace control piston 84 from respective first positions associated with the spray mode to respective second position associated with the purge mode. Control valve 26 can then shift positions, such as due to the user releasing the trigger 22, to direct the compressed air through a second internal pathway within spray applicator 12 to displace the control piston 84 of control assembly 24 and dose piston 86 from the respective second positions to the respective first positions.

Spray applicator 12 is initially in the purge mode such that the first passage 42 and second passage 44 are fluidly connected to mix chamber 30 and spray applicator 12 emits purge air through spray orifice 32. The user actuates trigger 22 to cause spray valve assembly 24 to transition to the first position associated with the spray mode. With spray valve assembly 24 in the first position, material pathways 34a, 34b are fluidly connected to mix chamber 30 while first passage 42 and second passage 44 are fluidly disconnected from mix chamber 30. The first and second base component materials flow into mix chamber 30 and mix within mix chamber 30 to form the plural component material. The plural component material is emitted from spray orifice 32.

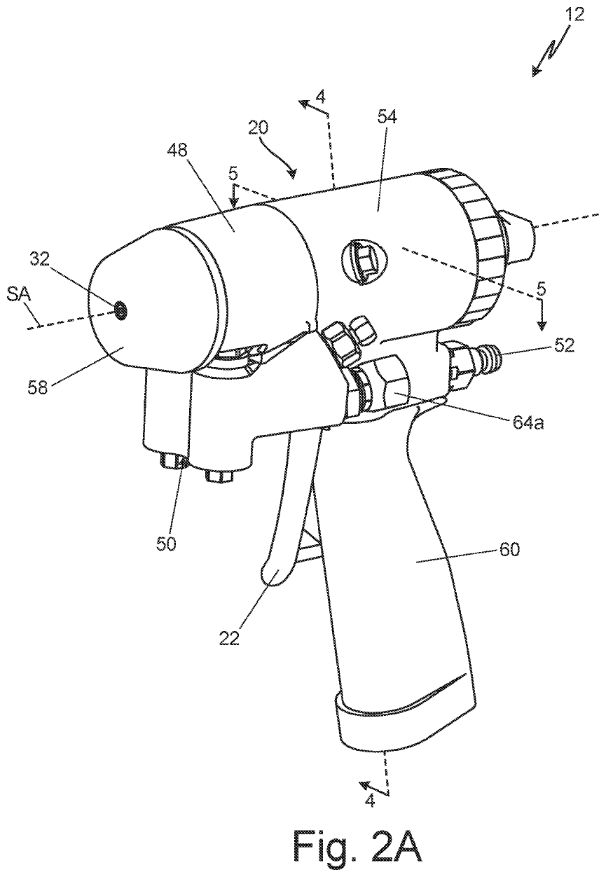

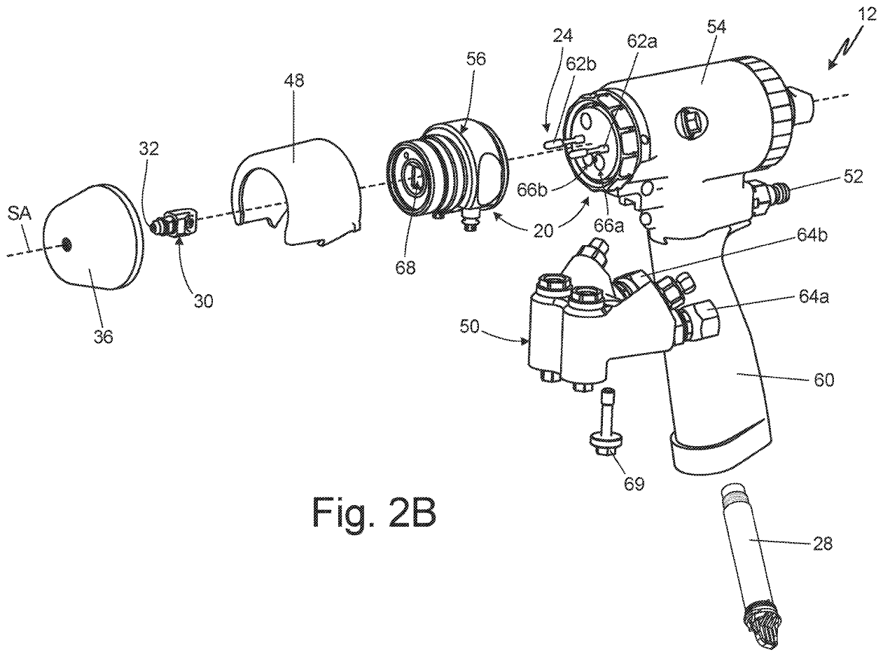

Spray valve 24 is maintained in the spray state until the user releases trigger 22. Upon release of trigger 22, control valve 26 shifts to direct pressurized air to spray valve assembly 24 to cause spray valve assembly 24 to shift to the second position associated with the purge mode. With spray valve assembly 24 in the second position, material pathways 34a, 34b are fluidly disconnected from mix chamber 30 and air pathway 38 is fluidly connected to mix chamber 30. More specifically, each of first passage 42 and second passage 44 are fluidly connected to mix chamber 30. Pressurized air flows into mix chamber 30 from both first passage 42 and second passage 44 and is emitted through spray orifice 32. The second purge air portion carries solvent from solvent reservoir 27 to mix chamber 30. The solvent can dissolve any plural component material within mix chamber 30 to prevent hardening and clogging. In some examples, the solvent is provided through only second passage 44 to prevent contact between the solvent and first the base component material provided through material pathway 34a at locations upstream of mix chamber 30. FIG. 2A is an isometric view of spray applicator 12. FIG. 2B is an exploded isometric view of spray applicator 12. FIGS. 2A and 2B will be discussed together. Spray applicator 12 includes body 20, trigger 22, spray valve 24, solvent cartridge 28, mix chamber 30, spray orifice 32, cover 48, material manifold 50, and air receiver 52. Body 20 includes support housing 54, fluid cartridge 56, retainer cap 58, and handle 60. Shuttles 62a, 62b of control assembly 24 are shown. Material manifold 50 includes base component inlet 64a and base component inlet 64b.

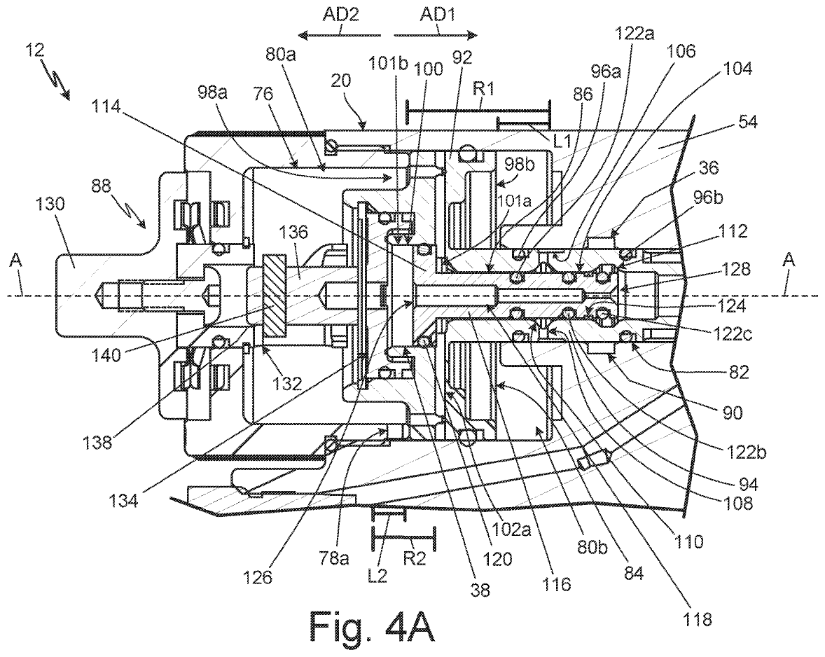

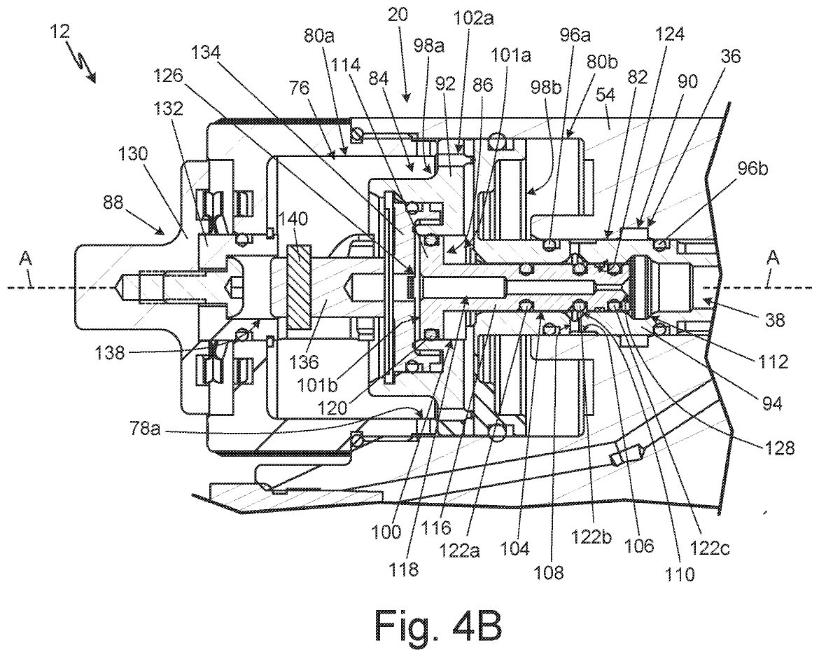

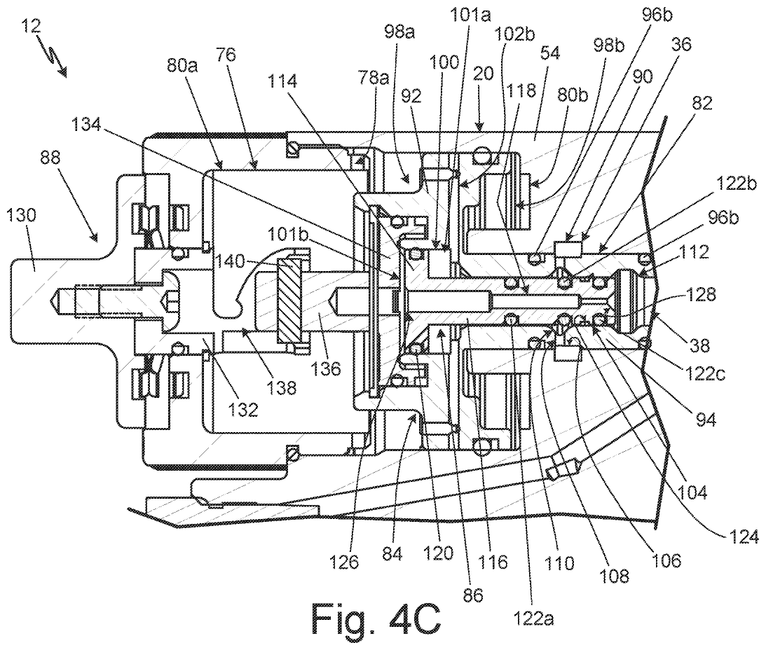

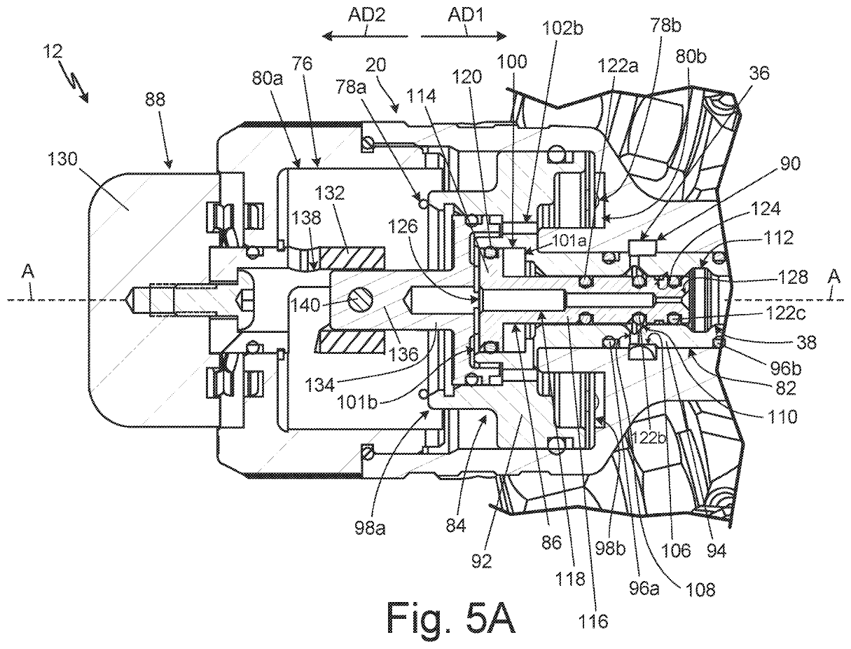

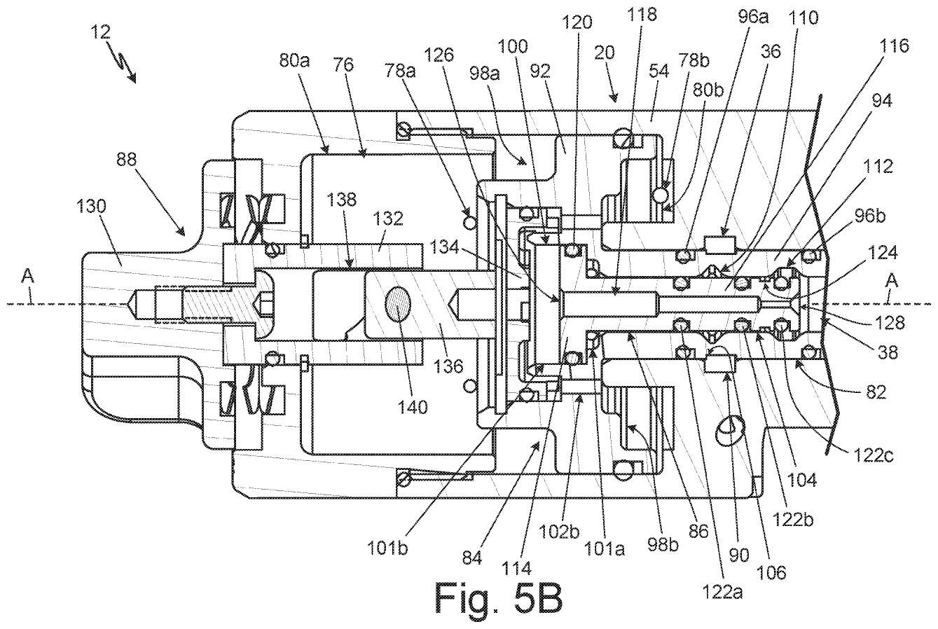

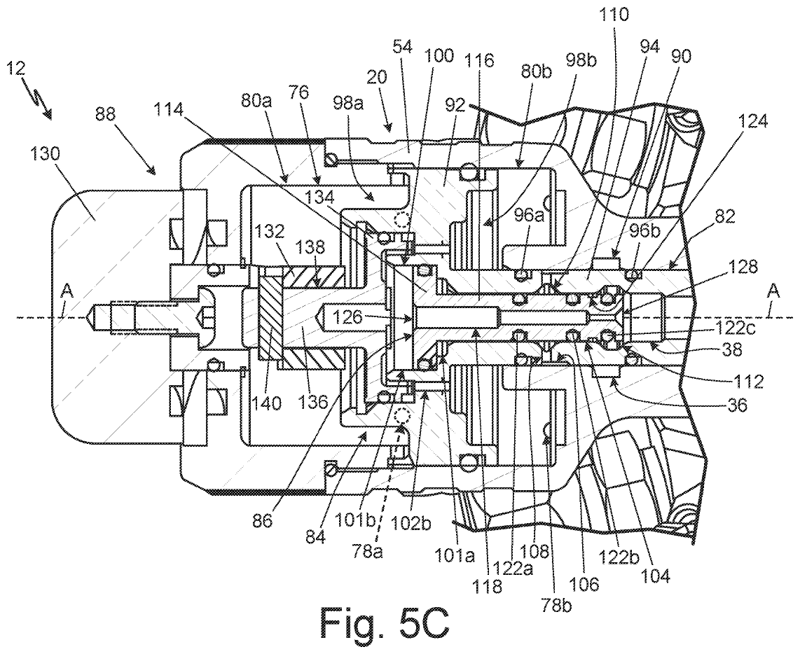

Body 20 supports other components of spray applicator 12. Body 20 can be formed as a unitary component or as multiple components fixed together. In the example shown, support housing 54 supports and at least partially encloses components of spray valve 24 and control valve 26. Fluid cartridge 56 is removably mountable to support housing 54. Handle 60 extends from support housing 54. The user can grasp handle 60 to manipulate and orient spray applicator 12. Handle 60 can, in some examples, house other components of spray applicator 12, such as solvent cartridge 28. An exhaust port can be formed through handle 60 to exhaust air from spray valve 24. Trigger 22 is supported by and can be connected to body 20. More specifically, trigger 22 is connected to support housing 54 in the example shown. Trigger 22 is configured to control spraying by spray applicator 12. Control assembly 24 is supported by spray applicator 12. In the example shown, control assembly 24 is at least partially disposed within support housing 54. Control assembly 24 includes shuttles 62a, 62b that project out of support housing 54 and into fluid cartridge 56. In the example shown, shuttles 62a, 62b form the flow control components of spray applicator 12. Shuttles 62a, 62b are configured to shift axially relative to spray axis SA to transition spray applicator 12 between the spray mode and the purge mode. The spray axis SA can be coaxial with the actuation axis A-A (FIGS. 4A-5C).

Fluid cartridge 56 is mountable to support housing 54. Fluid cartridge 56 can be connected to support housing 54 in any desired manner. For example, fluid cartridge 56 can be connected to support housing 54 by interfaced threading, among other options.

Cover 48 extends at least partially around fluid cartridge 56. In the example shown, cover 48 covers the interface between fluid cartridge 56 and support housing 54. Cover 48 can be connected to support housing 54 and/or fluid cartridge 56. Retainer cap 58 is attached to fluid cartridge 56. Retainer cap 58 is configured to secure internal components within spray applicator 12, such as by securing mix chamber 30 within cavity 68. It is understood, however, that mix chamber 30 can be secured to body 20 in any suitable manner.

Material manifold 50 is mountable to spray applicator 12 and configured to provide the first and second base component materials to fluid cartridge 56. Material manifold 50 is mounted to support housing 54 by fastener 69, though it is understood that other connection types are possible. Base component inlet 64a is a fitting configured to connect to a hose or other fluid line to receive the first base component material from a first material supply (e.g., fluid supply 14a (FIGS. 1A and 1B)). Base component inlet 64b is a fitting configured to connect to a hose or other fluid line to receive the second base component material from a second material supply (e.g., fluid supply 14b (FIGS. 1A and 1B)).

Air receiver 52 is mounted to spray applicator 12 and provides a location for compressed air to enter into spray applicator 12. In the examples shown, air receiver 52 is mounted to a back end of support housing 54 while fluid cartridge 56 is mounted to a front end of support housing 54. Air receiver 52 is a fitting configured to connect to a hose, pipe, tube, or other air line to receive pressurized air form an air source (e.g., air supply 18 (FIGS. 1A and 1B)).

Solvent cartridge 28 is mountable to spray applicator 12. Solvent cartridge 28 forms the solvent reservoir 27 of spray applicator 12 in the example shown. In the example shown, solvent cartridge 28 is configured to mount within handle 60.

During operation, the first base component material is provided to spray applicator 12 at base component inlet 64a, the second base component material is provided to spray applicator 12 at base component inlet 64b, and compressed air is provided to spray applicator 12 at air receiver 52. Spray valve 24 controls flows of the base component materials and compressed purge air to mix chamber 30. Trigger 22 controls actuation of control assembly 24 to place spray applicator 12 in the spray and purge states. With control assembly 24 in the first position associated with the spray mode, the first and second base component materials flow to and mix within mix chamber 30 and the resulting plural component material is emitted through spray orifice 32. Shuttles 62a, 62b prevent the purge air from flowing into mix chamber 30 with spray applicator 12 in the spray state. With control assembly 24 in the second position associated with the purge mode, the purge air portions flow to and mix within mix chamber 30 and the resulting combination of air and solvent is emitted through spray orifice 32. Shuttles 62a, 62b prevent the first and second base component materials from flowing into mix chamber 30 with spray applicator 12 in the purge mode.

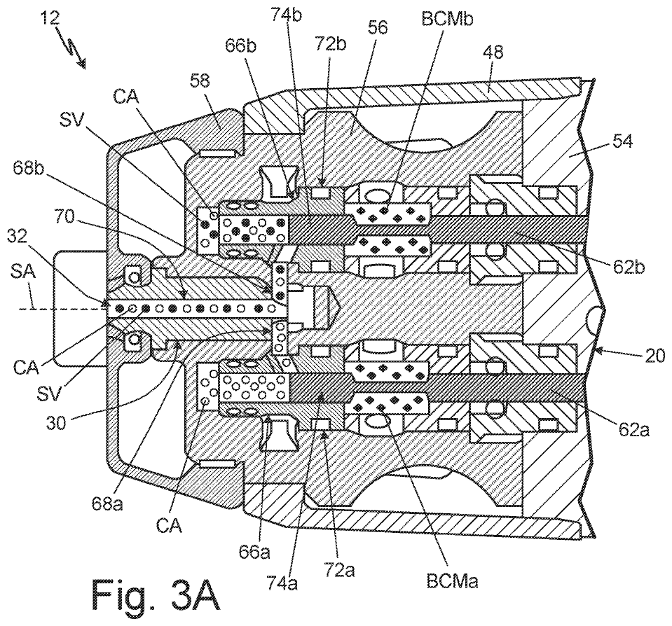

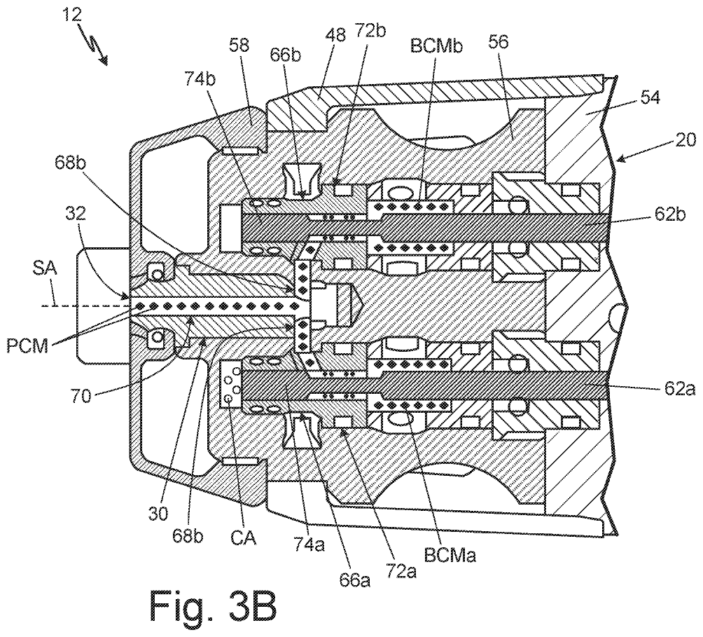

FIG. 3A is an enlarged cross-sectional view of a portion of a spray applicator 12 in a purge state. FIG. 3B is an enlarged cross-sectional view of the portion of the spray applicator 12 shown in FIG. 3A in a spray state. FIGS. 3A and 3B are discussed together. Body 20, mix chamber 30, spray orifice 32, cover 48, and seal cartridges 66a, 66b of spray applicator 12 are shown. Support housing 54, fluid cartridge 56, and retainer cap 58 of body 20 are shown. Shuttles 62a, 62b of control assembly 24 are shown. Mix chamber 30 includes spray orifice 32, inlet ports 68a, 68b, and mixing bore 70.

Spray applicator 12 is configured to receive separate flows of first and second base component materials BCMa, BCMb and to emit a plural component material PCM formed by the first and second base component materials mixing within mix chamber 30. Body 20 supports other components of spray applicator 12.

Shuttles 62a, 62b are operatively connected to a control piston 84 (FIGS. 3A-5) of control assembly 24 to be moved by the control piston 84. The control piston 84 and shuttles 62a, 62b can be considered to form the control assembly 24. In some examples, shuttles 62a, 62b are normally in the position shown in FIG. 3A such that spray applicator 12 is in the purge mode and emitting purge air. Shuttles 62a, 62b shift in first axial direction AD1 to the positions shown in FIG. 3B to place spray applicator 12 in the spray mode. Shuttles 62a, 62b shift in second axial direction AD2 to the positions shown in FIG. 3A to place spray applicator 12 back in the purge mode.

Seal cartridges 66a, 66b are disposed within fluid bores 72a, 72b, respectively. Fluid bores 72a, 72b are formed within fluid cartridge 56. Heads 74a, 74b of shuttles 62a, 62b interface with seal cartridges 66a, 66b, respectively, to control the flows of base component materials and purge air to mix chamber 30. Mix chamber 30 is disposed within cavity 68. Inlet ports 68a, 68b extend through mix chamber 30 to mixing bore 70. Mixing bore 70 can be disposed coaxially with spray axis SA. Mixing bore 70 extends to spray orifice 32.

During operation, spray applicator 12 is placed in the spray mode to generate and emit the plural component material PCM from spray orifice 32, and spray applicator 12 is placed in the purge mode to emit compressed air CA from spray orifice 32 as purge air. To place spray applicator 12 in the spray mode, the user depresses trigger 22, thereby causing control valve 26 to route driving air to the chamber that the head of control piston 84 is disposed within. The driving air exerts force on control piston 84 to displace the moving components of control assembly 24 in first axial direction AD1 and to the positions shown in FIG. 3B.

With shuttles 62a, 62b in the positions associated with the spray state shown in FIG. 3B, heads 74a, 74b of shuttles 62a, 62b are disposed on a first axial side of the inlet ports 68a, 68b and seal against seal cartridges 66a, 66b. For example, heads 74a, 74b can interface directly with the bodies of seal cartridges 66a, 66b or with seal members (e.g., elastomer sealing members, such as o-rings) supported by seal cartridges 66a, 66b or supported by heads 74a, 74b. The interfaces between heads 74a, 74b and seal cartridges 66a, 66b fluidly isolate the first and second purge air flows from mix chamber 30 while the first and second base component material flows are fluidly connected to mix chamber 30. In some examples, the second purge air portion is formed by a portion of the driving air that displaces the control piston 84, as discussed in more detail below. With spray applicator 12 in the purge mode, the second purge air portion is prevented from flowing downstream out of the chamber that the head of control piston 84 is disposed within. As such, while the head 74b of shuttle 62b is positioned to inhibit flow of purge air, no purge air may be present in the portion of second passage 44 adjacent head 74b with spray applicator 12 in the spray mode.

The first base component material flows through seal cartridge 66a and enters mix chamber 30 through inlet port 68a. The second base component material flows through seal cartridge 66b and enters mix chamber 30 through inlet port 68b. The first and second base component materials interact within mixing bore 70 to form the plural component material that is emitted through spray orifice 32.

Spray applicator 12 is detriggered (e.g., the user releases trigger 22) to cause spray applicator 12 to transition from the spray mode to the purge mode shown in FIG. 3A. Control valve 26 shifts position to direct the driving air to the chamber that the head of control piston 84 is disposed within but on an opposite side of the head of control piston 84 from the air that displaces control piston 84 to the spray mode. The driving air exerts force on control piston 84 to displace the moving components of control assembly 24 in second axial direction AD2, placing the spray applicator 12 in the purge mode.

With shuttles 62a, 62b in the positions shown in FIG. 3A, heads 74a, 74b are disposed on a second axial side of inlet ports 68a, 68b, opposite the first axial side, and seal against seal cartridges 66a, 66b. For example, heads 74a, 74b can interface directly with the bodies of seal cartridges 66a, 66b or with seal members (e.g., elastomer sealing members, such as o-rings) supported by seal cartridges 66a, 66b or supported by heads 74a, 74b. The interfaces between heads 74a, 74b and seal cartridges 66a, 66b fluidly connect the first and second purge air flows with mix chamber 30 while the flows of the first and second base component materials BCMa, BCMb are fluidly isolated from mix chamber 30. The first purge air portion flows through seal cartridge 66a and enters mix chamber 30 through inlet port 68a. The second pneumatic purge portion, including the entrained solvent SV, flows through seal cartridge 66b and enters mix chamber 30 through inlet port 68b. The first and second pneumatic purge portions interact within mixing bore 70 and are emitted through spray orifice 32.

Both of the first base component material and the first purge air portion flow through a common portion of seal cartridge 66a and through inlet port 68a. As such, seal cartridge 66a and inlet port 68a define portions of both material pathway 34a (FIG. 1B) and first passage 42 (FIG. 1B). Both of the second base component material and the second purge air portion flow through a common portion of seal cartridge 66b and inlet port 68b. As such, seal cartridge 66b and inlet port 68b define portions of both material pathway 34b (FIG. 1B) and second passage 44 (FIG. 1B).

In the example shown, the solvent is carried to mix chamber 30 by the second purge air portion. The first purge air portion is fluidly isolated from the solvent at locations upstream of mix chamber 30. In the example shown, the first and second purge air portions are sourced from the same supply of compressed air upstream of spray applicator 12 (e.g., from air supply 18) and from the same supply path within spray applicator 12 (e.g., common passage 40 (FIG. 1B)). The pneumatic pressure is balanced across the first and second purge air portions such that the first purge air portion is prevented from crossing over and flowing through inlet port 68b and such that the second purge air portion is prevented from crossing over and flowing through inlet port 68a. The balanced pressure prevents the solvent carried by the second purge air portion from flowing to inlet port 68a and upstream from inlet port 68a, such as into seal cartridge 66a or other portions of the material pathway 34a or first passage 42.

FIG. 4A is an enlarged cross-sectional view of a portion of a spray applicator 12 taken along line 4-4 in FIG. 2A, showing the spray applicator 12 in a purge state. FIG. 4B is an enlarged cross-sectional view of the portion of the spray applicator 12 shown in FIG. 4A, showing the spray applicator 12 in a first transition state. FIG. 4C is an enlarged cross-sectional view of the portion of the spray applicator 12 shown in FIG. 4A, showing the spray applicator 12 in a spray state. FIG. 5A is an enlarged cross-sectional view of a portion of a spray applicator 12 taken along line 5-5 in FIG. 2A, showing the spray applicator 12 in the spray state. FIG. 5B is an enlarged cross-sectional view of the portion of the spray applicator 12 shown in FIG. 5A, showing the spray applicator 12 in a second transition state. FIG. 5C is an enlarged cross-sectional view of the portion of the spray applicator 12 shown in FIG. 5A, showing the spray applicator 12 in the purge state. FIGS. 4A-5C will be discussed together.

Body 20, control piston 84, dose piston 86, and spray lock 88 of spray applicator 12 are shown. Support housing 54, piston bore 82, and supply groove 90 of body 20 are shown. Second passage 44 of air pathway 38 is shown.

Control piston head 92, control piston shaft 94, and shaft seals 96a, 96b of control piston 84 are shown. Control piston head 92 includes axial side 98a, axial side 98b, dose head chamber 100, and displacement passages 102a, 102b. Control piston shaft 94 includes shaft bore 104, solvent groove 106, solvent passage 108, holding groove 110, and dosing groove 112. Dose piston head 114, dose piston shaft 116, purge air bore 118, head seal 120, and dosing seals 122a-122c of dose piston 86 are shown. Dose piston shaft 116 includes carrying groove 124.

Control piston 84 and dose piston 86 are disposed coaxially on actuation axis A-A. Control piston 84 is configured to reciprocate between a first control position associated with emission of purge air and a second control position associated with emission of the plural component material. Dose piston 86 is configured to reciprocate between a first dose position associated with dosing solvent into the purge air and a second dose position associated with picking up solvent from the solvent pathway 36. Dose piston 86 moves relative to control piston 84 between the first dose position and the second dose position. Control piston 84 is shown in the first control position in FIGS. 4A, 4B, 5C. Control piston 84 is shown in the second control position in FIGS. 4C, 5A, 5B. Dose piston 86 is shown in the first dose position in FIGS. 4A, 5B, 5C. Dose piston 86 is shown in the second dose position in FIGS. 4B, 4C, 5A.

Control piston 84 is configured to control spraying by spray applicator 12. Control piston 84 can form a component of control assembly 24 of sprayer. Shuttles 62a, 62b are actuated by control piston 84 to move between a first position associated with the purge mode (the first position shown in FIG. 3A) and a second position associated with the spray mode (the second position shown in FIG. 3B). Control piston 84 is connected to shuttles 62a, 62b (best seen in FIGS. 3A and 3B) to axially displace shuttles 62a, 62b and actuate spray applicator 12 between the spray mode and purge mode. In some examples, control piston 84 is directly connected to shuttles 62a, 62b. Body 20 at least partially defines drive chamber 76. Body 20 defines various of the flowpaths forming the air pathway 38 of the spray applicator 12. Body 20 defines various of the flowpaths of the solvent pathway 36 of the spray applicator 12.

Drive chamber 76 is formed at least partially in body 20. Inlet passages 78a, 78b are formed in body 20. Inlet passages 78a, 78b admit compressed air to drive chamber 76. Inlet passages 78a, 78b are disposed on opposite axial sides of control piston head 92. Inlet passage 78a is associated with a first sub-chamber 80a of drive chamber 76 that is partially defined by axial side 98a of control piston 84. Inlet passage 78b is associated with a second sub-chamber 80b of drive chamber 76 that is partially defined by axial side 98b of control piston 84. Control piston 84 can interface with body 20 within drive chamber 76 such that body 20 aligns control piston 84 for movement along actuation axis A-A. Piston bore 82 is formed within body 20. Control piston 84 is at least partially disposed within piston bore 82. Control piston 84 can interface with body 20 within piston bore 82 such that piston bore 82 aligns control piston 84 for movement along the actuation axis A-A.

Control piston head 92 is disposed within drive chamber 76. Control piston head 92 divides drive chamber 76 into a sub-chamber 80a and the separate sub-chamber 80b. The sub-chambers 80a, 80b are fluidly isolated from each other by the control piston head 92. Drive chamber 76 defines the axial displacement range of the control piston 84. Drive chamber 76 defines the axial distance that control piston 84 can travel relative to the body 20. Control piston 84 can travel within the axial range R1. Control piston 84 can travel a length L1 between the spray and purge states.

Axial side 98a of control piston head 92 is oriented in second axial direction AD2 and axial side 98b of control piston head 92 is oriented in first axial direction AD1. Axial side 98a is exposed to and at least partially defines sub-chamber 80a. Axial side 98b is exposed to and at least partially defines sub-chamber 80b. Axial side 98a and axial side 98b are exposed to the compressed air within sub-chamber 80a and sub-chamber 80b, respectively, such that the compressed air acts on the axial side 98a or axial side 98b to drive displacement of control piston 84. Compressed air provided to sub-chamber 80a acts on axial side 98a to displace control piston 84 in the first axial direction AD1. Compressed air provided to sub-chamber 80b acts on axial side 98b to displace control piston 84 in the second axial direction AD2.

Dose head chamber 100 is formed within control piston head 92. Dose piston head 114 is disposed within and retained within dose head chamber 100. Dose head chamber 100 defines the axial displacement range of the dose piston 86. Dose head chamber 100 defines the axial distance that dose piston 86 can travel relative to the control piston 84. Dose piston 86 can travel within the axial range R2. Dose piston 86 can travel a length L2 between the spray and purge states.

Displacement passages 102a, 102b are formed though control piston head 92 and extend to dose head chamber 100. Displacement passages 102a, 102b are flow passages that are configured to provide compressed air to dose head chamber 100. The compressed air provided to dose head chamber 100 is configured to actuate dose piston 86 along actuation axis A-A.

Displacement passages 102a include inlets through axial side 98a of control piston head 92 and outlets into dose head chamber 100. Displacement passages 102a are fluidly connected to sub-chamber 80a and to dose head chamber 100. Displacement passages 102a are configured to receive air on a first axial side of dose piston head 114 and output air into dose head chamber 100 on a second axial side of dose piston head 114. Displacement passages 102a extend axially around the dose head seal 120 to introduce compressed air into dose head chamber 100 on the opposite side of dose head seal 120 from where displacement passages 102a receive the air. The compressed air provided to dose head chamber 100 through displacement passages 102a is configured to displace dose piston 86 in second axial direction AD2. The displacement passages 102a provide flowpaths through control piston head 92 that admit compressed air to dose head chamber 100 on an axial side of the dose piston head 114 oriented in the first axial direction AD1. The displacement passages 102a are configured to introduce compressed air to dose head chamber 100 to drive dose piston 86 in second axial direction AD2 from the first dose position to the second dose position. Displacement passages 102a include inlets that are oriented axially, in second axial direction AD2 in the example shown, and outlets that are oriented radially into dose head chamber 100. Displacement passages 102a reorient the flow direction of the compressed air to output the compressed air radially into dose head chamber 100.

Displacement passages 102b include inlets through axial side 98b of control piston head 92 and outlets into dose head chamber 100. Displacement passages 102b are fluidly connected to sub-chamber 80b and to dose head chamber 100. Displacement passages 102b are configured to receive air on a second axial side of dose piston head 114 and output air into dose head chamber 100 on a first axial side of dose piston head 114. Displacement passages 102b extend axially around the dose head seal 120 to introduce compressed air into dose head chamber 100 on the opposite side of dose head seal 120 from where displacement passages 102b receive the air. The compressed air provided to dose head chamber 100 through displacement passages 102b is configured to displace dose piston 86 in first axial direction AD1. The displacement passages 102a provide flowpaths through control piston head 92 that admit compressed air to dose head chamber 100 on an axial side of the dose piston head 114 oriented in the second axial direction AD2. The displacement passages 102b are configured to introduce compressed air to dose head chamber 100 to drive dose piston 86 in second axial direction AD2 from the second dose position to the first dose position. The compressed air provided through displacement passages 102b can form at least a portion of the purge air of spray applicator 12. The compressed air provided through displacement passages 102b can flow through purge air bore 118 in dose piston 86 and downstream to entrain solvent and carry the solvent to mix chamber 30.

Supply groove 90 extends into body 20. Supply groove 90 extends radially outward relative to the actuation axis A-A from piston bore 82. Supply groove 90 can extend fully about the actuation axis A-A. Supply groove 90 can be formed as an annular groove. In the example shown, supply groove 90 is formed as a ring for holding a volume of solvent. Supply groove 90 forms a portion of the solvent circuit and is fluidly connected to the solvent source (e.g., solvent cartridge 28). In the example shown, supply groove 90 is fluidly connected to the solvent source throughout operation. With control piston 84 extending into piston bore 82, the supply groove 90 can be considered to form a solvent supply chamber that provides solvent for entrainment in the purge air.

Control piston shaft 94 extends from control piston head 92. Control piston shaft 94 extends into piston bore 82 formed in the body 20. Control piston shaft 94 extends in first axial direction AD1 from control piston head 92. Control piston shaft 94 can be cylindrical and piston bore 82 can be cylindrical. Shaft seal 96a and shaft seal 96b are disposed on control piston shaft 94. Shaft seal 96a and shaft seal 96b are disposed on opposite axial sides of solvent groove 106 formed in body 20 throughout operation. Shaft seal 96a and shaft seal 96b engage with and seal against body 20 throughout operation as control piston 84 reciprocates within piston bore 82. Shaft seal 96a and shaft seal 96b prevent solvent from leaking axially beyond either shaft seal 96a, 96b between control piston shaft 94 and body 20. In the example shown, each shaft seal 96a, 96b is disposed in a seal groove formed on the outer radial surface of control piston shaft 94. Shaft seals 96a, 96b can be of any configuration suitable for fluidly sealing between control piston shaft 94 and body 20, such as elastomer seals. For example, shaft seals 96a, 96b can be formed as o-rings, among other options. In the example shown, shaft seals 96a, 96b are formed as dynamic seals that slide axially relative to body 20 as spray applicator 12 is actuated between the spray and purge states.

Solvent groove 106 is formed on an outer radial surface of control piston shaft 94. Solvent groove 106 is disposed axially between shaft seals 96a, 96b. The solvent groove 106 is disposed axially between the seal grooves holding the shaft seals 96a, 96b. Solvent groove 106 is formed as a depression in the outer surface of control piston shaft 94. Solvent groove 106 can extend annularly. Solvent groove 106 can extend fully about control piston shaft 94. Solvent groove 106 can extend fully circumferentially about actuation axis A-A. Solvent groove 106 is configured to hold a volume of solvent between body 20 and control piston shaft 94 for quick supply to holding groove 110.

A solvent chamber is partially defined by body 20 in the example shown. The solvent chamber is formed by body 20 and control piston 84. The solvent chamber includes supply groove 90, solvent groove 106, and the axial passage therebetween. A length of the axial passage varies throughout operation as the control piston 84 reciprocates relative to body 20. The supply groove 90 can also be referred to as a body groove. The solvent groove 106 can also be referred to as a piston groove.

Solvent passages 108 extend through the body of control piston 84 between holding groove 110 and an exterior of the control piston 84. In the example shown, solvent passages 108 extend radially between solvent groove 106 and holding groove 110. The outer radial openings of solvent passages 108 are formed through the exterior surface of control piston shaft 94. The outer radial openings can also be referred to as solvent inlets. The inner radial openings of solvent passages 108 are formed through the inner radial surface of control piston shaft 94. The inner radial openings can also be referred to as solvent outlets. The solvent outlets are formed in holding groove 110, in the example shown. Solvent passages 108 form flowpaths that allow solvent to flow through control piston shaft 94 from an exterior of control piston 84 to an interior of control piston 84. Specifically, the solvent passages 108 form flowpaths for the solvent to flow between solvent groove 106 and holding groove 110.

Holding groove 110 is formed in control piston shaft 94. Holding groove 110 extends radially outward relative to the actuation axis AA from shaft bore 104. Holding groove 110 can extend fully about the actuation axis AA. Holding groove 110 can be formed as an annular groove. In the example shown, holding groove 110 is formed as a ring for holding a volume of solvent. Holding groove 110 forms a portion of the solvent pathway 36 and is fluidly connected to the solvent source (e.g., solvent cartridge 28). The holding groove 110 can be fluidly connected to the solvent reservoir 27 throughout operation of spray applicator 12. The solvent reservoir 27 can be pressurized such that the pressurized solvent is fluidly connected to and supply groove 90, solvent groove 106, solvent passages 108, and holding groove 110 throughout operation.

Dose piston 86 is at least partially disposed within control piston 84. In the example shown, dose piston 86 is fully disposed within control piston 84. Dose piston 86 does not extend axially outward from control piston 84 in the example shown. Dose piston 86 is supported by control piston 84. Dose piston 86 is movable relative to control piston 84. As such, control piston 84 can be considered to carry dose piston 86 without being connected to dose piston 86.

Dose piston head 114 is disposed within dose head chamber 100. Dose piston shaft 116 extends from dose piston head 114. Dose piston shaft 116 extends into shaft bore 104 that is formed within control piston 84. Dose piston shaft 116 is configured to slide axially within the shaft bore 104 relative to control piston 84. Shaft bore 104 can extend fully axially through control piston shaft 94, in some examples. Dose piston shaft 116 extends in first axial direction AD1 from dose piston head 114. As such, dose piston shaft 116 and control piston shaft 94 extend in the same axial direction from dose piston head 114 and control piston head 92, respectively. Dose piston shaft 116 rides within shaft bore 104 but is not secured to shaft bore 104 to allow dose piston shaft 116 to move relative to control piston shaft 94. Dose piston 86 can interface with control piston shaft 94 within shaft bore 104 such that shaft bore 104 aligns dose piston 86 for movement along the actuation axis A-A.

Dosing seals 122a-122c are disposed on dose piston shaft 116. Dosing seals 122a-122c are disposed radially between dose piston shaft 116 and control piston shaft 94. Dosing seals 122a-122c engage with the inner radial surface of control piston shaft 94 that defines shaft bore 104 to prevent solvent from leaking axially between dose piston 86 and control piston 84. In the example shown, each dosing seal 122a-122c is disposed in a seal groove formed on the outer radial surface of dose piston shaft 116. Dosing seals 122a-122c can be of any configuration suitable for fluidly sealing between dose piston shaft 116 and control piston shaft 94, such as elastomer seals. For example, dosing seals 122a-122c can be formed as o-rings, among other options. In the example shown, dosing seals 122a-122c are formed as dynamic seals that slide axially relative to control piston 84 as dose piston 86 is actuated along axis A-A and moves relative to control piston 84.

Dosing seal 122a is disposed at a first axial location on dose piston shaft 116. Dosing seal 122b is disposed at a second axial location on dose piston shaft 116. Dosing seal 122c is disposed at a third axial location on dose piston shaft 116. The first location is disposed axially between dose piston head 114 and the second axial location. Dosing seal 122a is located such that dosing seal 122a is located on a first axial side of holding groove 110 throughout operation. Dosing seal 122a is located such that dosing seal 122a is in contact with and seals against control piston shaft 94 throughout operation, as discussed in more detail below.

Dosing seal 122b is located axially between dosing seal 122a and dosing seal 122c. Dosing seal 122b can be considered to form an intermediate seal of the dosing seals 122a-122c, while dosing seals 122a, 122c form end seals of the dosing seals 122a-122c. Dosing seal 122b is configured to be in contact with the control piston shaft 94 during portions of the reciprocation of dose piston 86. Dosing seal 122b is configured to interface with a portion of control piston shaft 94 disposed on an opposite axial side of holding groove 110 from dosing seal 122a. Dosing seal 122b interfaces with control piston shaft 94 with spray applicator 12 in the purge mode. Dosing seal 122b interfacing with control piston shaft 94 fluidly isolates holding groove 110 from dosing groove 112. Dosing seal 122b thereby fluidly isolates the solvent pathway 36 and air pathway 38 when dosing seal 122b is engaged with control piston shaft 94. Dosing seal 122b engages with a portion of control piston shaft 94 spaced in first axial direction AD1 from holding groove 110.

Dosing seal 122b does not interface with the control piston shaft 94 throughout the entirety of operation. Dosing seal 122b disengages from control piston shaft 94 and is disposed to radially overlap with holding groove 110, such that a radial line extending from actuation axis A-A extends through both dosing seal 122b and holding groove 110, with spray applicator 12 in the spray state. Dosing seal 122b disengaging from control piston shaft 94 fluidly connects the holding groove 110 and carrying groove 124. Dosing seal 122b disengaging from control piston shaft 94 fluidly connects the carrying groove 124 with the solvent pathway 36 such that solvent can flow to and enter into the carrying groove 124.

Dosing seal 122c is located at an end of dose piston shaft 116 opposite dose piston head 114. Dosing seal 122c forms a distal seal of dose piston 86. Dosing seal 122c is spaced in first axial direction AD1 from dosing seal 122a and dosing seal 122b. Dosing seal 122c is disposed on an opposite axial side of carrying groove 124 from dosing seal 122b. Dosing seal 122c is configured to interface with a portion of control piston shaft 94 on an opposite axial side of holding groove 110 from dose piston head 114. Dosing seal 122c can interface with the same portions of control piston shaft 94 as dosing seal 122b. Dosing seal 122c interfaces with control piston shaft 94 with spray applicator 12 in the spray mode. Dosing seal 122c interfacing with control piston shaft 94 fluidly isolates holding groove 110 from dosing groove 112. Dosing seal 122c thereby fluidly isolates the solvent pathway 36 and air pathway 38.

Dosing seal 122c does not interface with the control piston 84 throughout the entirety of operation. Dosing seal 122c disengages from control piston shaft 94 and is disposed within dosing groove 112 with spray applicator 12 in the purge mode. Dosing seal 122c disengaging from control piston shaft 94 fluidly connects the carrying groove 124 with dosing groove 112. Dosing seal 122c disengaging from control piston shaft 94 fluidly connects the carrying groove 124 with the air pathway 38 such that solvent can flow to and be entrained within the purge air flowing through air pathway 38.

Dosing seals 122a-122c are configured to fluidly isolate the holding groove 110 from the pneumatic pathways of spray applicator 12. Dosing seal 122a is maintains contact with control piston shaft 94 throughout operation to prevent solvent from flowing in second axial direction AD2 between control piston shaft 94 and dose piston shaft 116. One or both of dosing seals 122b, 122c are engaged with control piston shaft 94 throughout operation. Dosing groove 112 is fluidly isolated from holding groove 110 throughout operation. In the example shown, dosing groove 112 is fluidly isolated from holding groove 110 by a dynamic sealing interface between dose piston 86 and control piston 84. The dynamic sealing interface fluidly separates the air pathway 38 and solvent pathway 36 of spray applicator 12. Specifically, dosing groove 112 is fluidly isolated from holding groove 110 by dosing seals 122b, 122c. Dosing seals 122b, 122c are located along dose piston shaft 116 such that at least one of dosing seals 122b, 122c is in contact with control piston shaft 94 throughout operation. The dynamic sealing interface prevents solvent from flowing in first axial direction AD1 between control piston shaft 94 and dose piston shaft 116. As dose piston 86 shifts in first axial direction ADI dosing seal 122b engages control piston shaft 94 prior to dosing seal 122c disengaging from control piston shaft 94. As dose piston 86 shifts in second axial direction AD2 dosing seal 122c engages control piston shaft 94 prior to dosing seal 122b disengaging from control piston shaft 94.

Carrying groove 124 is formed on dose piston 86. Specifically, carrying groove 124 is formed on dose piston shaft 116. Carrying groove 124 extends radially inward into dose piston shaft 116. Carrying groove 124 is formed as a depression in dose piston shaft 116. Carrying groove 124 is disposed axially between dosing seal 122b and dosing seal 122c. Carrying groove 124 can be considered to be axially bracketed by the dosing seals 122b, 122c. Carrying groove 124 can be formed as an annular groove around dose piston shaft 116. Carrying groove 124 can extend fully about the actuation axis A-A. Carrying groove 124 is configured to pick up a dose volume of solvent from holding groove 110 and transfer that solvent to dosing groove 112. The solvent is then entrained within the purge air flowing through air pathway 38 (e.g., entrained within second purge air portion through second passage 44) and carried by the purge air to the mix chamber 30.

Purge air bore 118 extends axially within dose piston 86. Purge air bore 118 extends fully axially through dose piston 86 in the example shown. Purge air bore 118 extends axially between purge bore inlet 126 and purge bore outlet 128. Purge air bore 118 defines a purge passage through dose piston 86 through which purge air flows to entrain the solvent and carry the solvent to mix chamber 30. Purge bore inlet 126 is formed in dose piston head 114. Purge bore inlet 126 is oriented axially in second axial direction AD2. Purge bore outlet 128 is formed in dose piston shaft 116. Purge bore outlet 128 is oriented axially in first axial direction AD1. Purge air bore 118 forms a portion of the air pathway 38 of spray applicator 12. Purge air bore 118 is in fluid communication with displacement passages 102b, and thus with sub-chamber 80b. Purge air bore 118 is configured to receive compressed air from sub-chamber 80b and that compressed air flows through purge air bore 118 and is output through purge bore outlet 128 into shaft bore 104.

In the example shown, purge air bore 118 is formed by a series of bores that progressively decrease in diameter as purge air bore 118 extends in first axial direction AD1. Purge bore inlet 126 has a larger diameter than purge bore outlet 128 in the example shown. The decreasing diameters of purge air bore 118 increases the velocity of the purge air flowing through purge air bore 118. Purge bore outlet 128 increases in diameter and opens into the larger diameter shaft bore 104, specifically into the portion of shaft bore 104 in which dosing groove 112 is formed. In some examples, purge air outlet 128 forms a seat for an airflow control valve, such as for a ball of the valve to seat on, that prevents retrograde flow through purge air bore 118. Purge bore outlet 128 opening into the larger diameter shaft bore 104 encourages turbulent flow to entrain the solvent within the purge air.

Spray lock 88 interfaces with control piston 84. Spray lock 88 is actuatable between an unlocked state and a locked state (shown in FIG. 5C). With spray lock 88 in the unlocked state, control piston 84 is able to reciprocate along the actuation axis A-A to transition shuttles 62a, 62b and place spray applicator 12 in the purge state. With spray lock 88 in the locked state, control piston 84 is held in the first control position that is associated with the purge state. Control piston 84 is prevented from shifting in first axial direction AD1 with spray lock 88 in the locked state. Spray lock 88 maintains control piston 84 in the first control position to prevent the user from inadvertently actuating spray applicator 12 to the spray state and causing emission of the plural component material. Spray lock 88 thereby forms a safety that prevents actuation to the spray state even when the pneumatic supply is connected to spray applicator 12 and activated to provide compressed air to spray applicator 12.

Lock knob 130 is connected to receiver 132 such that lock knob 130 can rotate receiver 132 about a lock axis. The lock axis is disposed coaxially with the actuation axis A-A, in the example shown. Each of spray lock 88, control piston 84, and dose piston 86 are aligned coaxially on the actuation axis A-A, in the example shown. Retainer 134 is connected to control piston 84. In the example shown, retainer 134 is partially disposed within a chamber formed in the control piston head 92 of control piston 84. Retainer 134 extends axially outward from axial side 98a of control piston head 92. A pneumatic seal is formed between retainer 134 and control piston 84, such as by an elastomer seal disposed radially between retainer 134 and control piston head 92. Retainer 134 can at least partially define the dose head chamber 100. Retainer 134 can be secured to control piston 84 in any desired manner, such as by a ring or clip snapped into a groove in the control piston 84.

Retainer 134 interfaces with receiver 132. In the example shown, retainer shaft 136 extends into receiver bore 138. Bar 140 interfaces with receiver 132 within one or more slots of receiver 132. Bar 140 extends through retainer shaft 136. Retainer 134 can move axially relative to the receiver 132 with spray lock 88 in the unlocked state. Retainer 134 is prevented from moving axially relative to the receiver 132 with spray lock 88 in the locked state. Rotating the lock knob 130 displaces bar 140 within the slot of receiver 132 such that control piston 84 is pulled to the first control position. In the example shown, the lock knob 130 rotates the receiver 132, the receiver 132 draws the retainer 134 in the second axial direction AD2 via bar 140, and the retainer 134 pulls the control piston 84 in the second axial direction AD2 to the first control position.

While spray lock 88 can secure control piston 84 in the position associated with the purge state, spray lock 88 does not secure dose piston 86. The dose piston 86 can freely reciprocate along the actuation axis A-A relative to control piston 84 while control piston 84 is secured in the first control position. Spray lock 88 does not interface with dose piston 86. Retainer 134 is not connected to dose piston 86. In some examples, retainer 134 defines an extent of axial movement of dose piston 86, but retainer 134 does lock a position of dose piston 86 relative to control piston 84.

Dose piston 86 being movable relative to the control piston 84 allows dose piston 86 to actuate between the first dose position and the second dose position, while control piston 84 remains stationary. The user can thus dose solvent into the purge air by triggering and detriggering spray applicator 12 without actuating spray applicator 12 to the spray state. During operation, the spray applicator 12 is initially in the purge state, with control piston 84 in the first control position and dose piston 86 in the first dose position. The initial state of spray applicator 12 is shown in FIGS. 4A and 5C. Shuttles 62a, 62b, which may be directly connected to control piston head 92 (e.g., by interfaced threading therebetween), are positioned to fluidly connect the purge air pathways with the mix chamber 30. The purge air flows through the mix chamber 30 and is emitted through spray orifice 32. Compressed air is initially directed to sub-chamber 80b to bias control piston 84 in second axial direction AD2. The compressed air acts on axial side 98b of control piston head 92 and exerts driving force on control piston head 92 in the first axial direction AD2. The compressed air can maintain control piston 84 in the first control position. A portion of that compressed air flows through inlet passages 78b and into dose head chamber 100. A portion of the compressed air entering into sub-chamber 80b flows to and through displacement passages 102b formed in control piston head 92. The compressed air flows through displacement passages 102b to dose head chamber 100 and exerts a force on dose piston head 114. The compressed air biases dose piston 86 in first axial direction AD1 to drive dose piston 86 to and maintain dose piston 86 in the first dose position. The displacement passages 102b provide flowpaths through control piston head 92 that admit compressed air to dose head chamber 100 on the axial side of the dose piston head 114 oriented in the second axial direction AD2. With spray applicator 12 in the purge state, the compressed air acts on opposite axial sides of the control piston 84 and the dose piston 86. The compressed air acts on a side of control piston 84 oriented in first axial direction AD1 and on a side of dose piston 86 oriented in second axial direction AD2. With spray applicator 12 in the purge state, the compressed air biases control piston 84 in second axial direction AD2 and biases dose piston 86 in first axial direction AD1.

The compressed air flows from a first axial side of the drive head seal 120 to a second, opposite axial side of the drive head seal 120. The compressed air flows on opposite axial sides of the drive head seal 120 with spray applicator 12 in the purge state. The compressed air flows within control piston 84 and on opposite axial sides of the drive head seal 120.

The compressed air biases dose piston 86 in first axial direction AD1 and also flows through the purge air bore 118 through dose piston 86. The compressed air flowing through the dose piston 86 forms at least a portion of the purge air flowing to mix chamber 30. In some examples, the compressed air flowing through dose piston 86 forms at least a portion of the second purge air portion. In some examples, all purge air flows through the purge air bore 118 in dose piston 86. The compressed air flows downstream through dose piston 86 and shaft bore 104 and to mix chamber 30. A purge valve can disposed in the pneumatic pathway between dose piston 86 and mix chamber 30 to prevent backflow of the purge air to dose piston 86. The purge valve maintains the pneumatic pressure in that downstream portion of the pneumatic pathway to provide quick reaction and flow of the purge air to and through mix chamber 30 when spray applicator 12 is actuated to the purge state.

The user actuates trigger 22 to cause spraying by spray applicator 12. The shifting of control piston 84 and dose piston 86 from positions associated with the purge mode to positions associated with the spray mode is shown in FIGS. 4A-4C. Control piston 84 and dose piston 86 are initially in the positions shown in FIG. 4A. Control piston 84 is in the first control position and dose piston 86 is in the first dose position. The user actuating trigger 22 causes control valve 26 to shift to direct compressed air to inlet passages 78a and stop flow of the compressed air to inlet passages 78b. The control valve 26 fluidly connects inlet passages 78b to an exhaust of the spray applicator 12. The compressed air enters into sub-chamber 80a through inlet passages 78a and acts on axial side 98a of control piston head 92 and biases control piston 84 in first axial direction AD1. The compressed air displaces control piston 84 in the first axial direction AD1 and displaces dose piston 86 in second axial direction AD2. A portion of the compressed air that is flowed to sub-chamber 80a flows through displacement passages 102a formed in control piston head 92. Displacement passages 102a include inlets through axial side 98a of control piston head 92 and outlets into dose head chamber 100. The compressed air enters into dose head chamber 100 and biases dose piston 86 in second axial direction AD2. The displacement passages 102a provide flowpaths through control piston head 92 that admit compressed air to dose head chamber 100 on an axial side of the dose piston head 114 oriented in the first axial direction AD1. The compressed air flows within control piston 84 and to the holding groove 110. With spray applicator 12 in and transitioning to the spray state, the compressed air acts on opposite axial sides of the control piston 84 and the dose piston 86. The compressed air acts on a side of control piston 84 oriented in second axial direction AD2 and on a side of dose piston 86 oriented in first axial direction AD1.

FIG. 4B shows spray applicator in a first transition state. FIG. 4B shows the dose piston 86 and control piston 84 in positions associated with opposite states for purposes of illustration. It is understood that during operation the compressed air acts on control piston 84 and dose piston 86 simultaneously. As such, while dose piston 86 and control piston 84 are shown in FIG. 4B in positions associated with opposite states (the control piston 84 in the first control position and the dose piston 86 in the second dose position), it is understood that dose piston 86 and control piston 84 move together between the states.

Control piston 84 moves in first axial direction AD1 to shift shuttles 62a, 62b and fluidly connected the base component material flows with mix chamber 30. The compressed air also displaces dose piston 86 relative to control piston 84. Dose piston 86 shifts in second axial direction AD2 as control piston 84 shifts in first axial direction AD1. Dose piston 86 moves in an axial direction opposite the control piston 84 as spray applicator 12 transitions to the spray state.

In the example shown, dose piston 86 moves relative to the control piston 84 and in an opposite direction from control piston 84, but dose piston 86 displaces relative to body 20 of spray applicator 12 in the same axial direction as control piston 84 as spray applicator 12 is transitioned between the spray and purge states. For example, the length L1, which is a displacement distance of control piston 84 relative to body 20, is greater than the length L2, which is a displacement distance of dose piston 86 relative to control piston 84, such that control piston 84 shifts a greater axial distance along the actuation axis A-A than the dose piston 86. As such, dose piston 86 shifts in axial direction AD1 relative to body 20 between the first dose position and the second dose position while dose piston 86 displaces in the opposite second axial direction AD2 relative to the control piston 84.

Dose piston 86 shifts in second axial direction AD2 relative to control piston 84 such that dose seal 122b disengages from control piston 84 and dose seal 122c engages with control piston 84. Carrying groove 124 is fluidly connected to holding groove 110. Solvent flows to and enters into carrying groove 124.

Spray applicator 12 is shown in the spray state in FIG. 4C. The compressed air is biasing control piston 84 in first axial direction AD1 and biasing dose piston 86 in second axial direction AD2. The dose head seal 120 fluidly isolates the compressed air provided through displacement passages 102a from the purge air bore 118 through dose piston 86. Dose head seal 120 divides the dose head chamber 100 into a dose chamber 101b and a reset chamber 101a. Air provided to reset chamber 101a drives dose piston 86 in second axial direction AD2 to fluidly connect carrying groove 124 with holding groove 110. Air provided to dose chamber 101b drives dose piston 86 in first axial direction AD1 to fluidly connect carrying groove 124 with dose groove 112. The same air that drives dose piston 86 in first axial direction AD1 flows through the purge air passage defined by purge air bore 118 to entrain the solvent. As such, the same air that drives dose piston 86 can also pick up and carry the solvent to mix chamber 30 for flushing mix chamber 30.

To stop spraying, the user releases trigger 22. Upon release of trigger 22, the spray applicator 12 is actuated to the purge state. Shifting of control piston 84 and dose piston 86 from positions associated with the spray mode to positions associated with the purge mode is shown in FIGS. 5A-5C. Control piston 84 and dose piston 86 are initially in the positions shown in FIG. 5A. Control piston 84 is in the second control position and dose piston 86 is in the second dose position. Releasing trigger 22 allows control valve 26 to shift states such that control valve 26 directs compressed air to inlet passages 78b and fluidly connects inlet passages 78a with an exhaust of spray applicator 12. The compressed air enters into sub-chamber 80b through inlet bores 78b. The compressed air flowing through inlet bores 78b acts on axial side 98b of control piston head 92 to bias control piston 84 in second axial direction AD2. The compressed air displaces control piston 84 in the second axial direction AD2 to move control piston 84 from the second control position shown in FIG. 5A to the first control position shown in FIG. 5C.

The compressed air provided to sub-chamber 80b flows through displacement passages 102b and to dose head chamber 100. The compressed air flowing through displacement passages 102b acts on dose piston head 114 to bias dose piston 86 in first axial direction AD1. The compressed air displaces dose piston 86 relative to control piston 84. Dose piston 86 shifts in first axial direction AD1 as control piston 84 shifts in second axial direction AD2. Dose piston 86 moves in an axial direction opposite the control piston 84 as spray applicator 12 transitions to the purge state from the spray state.

In the example shown, dose piston 86 moves relative to the control piston 84 and in an opposite direction from control piston 84, but dose piston 86 displaces in the same axial direction as control piston 84 relative to body 20.

FIG. 5B shows spray applicator 12 in a second transition state. It is understood that during operation the compressed air acts on control piston 84 and dose piston 86 simultaneously. As such, while dose piston 86 and control piston 84 are shown in FIG. 5B in positions associated with opposite states, it is understood that dose piston 86 and control piston 84 actuate together between the states. FIG. 3B shows the dose piston 86 and control piston 84 in positions associated with opposite states for purposes of illustration. Dose piston 86 is shown in the first dose position associated with emission of purge air while control piston 84 is shown in the second control position associated with the emission of the plural component material. The compressed air continues to act on control piston 84 and dose piston 86 to drive the control piston 84 and dose piston 86 to the positions shown in FIG. 5C.

The compressed air flowing through displacement passages 102b and into dose head chamber 100 is fluidly connected to the purge air bore 118 through dose piston 86. A portion of that compressed air flows through purge air bore 118 and is emitted through purge bore outlet 128 and into shaft bore 104. That compressed air flows downstream through shaft bore 104, and in some examples through flowpaths in body 20, to the mix chamber 30 for emission as purge air.

Dose piston 86 shifts in first axial direction AD1 such that dose seal 122b engages control piston 84 and dose seal 122c disengages from control piston 84. Carrying groove 124 is fluidly connected to dosing groove 112 and fluidly disconnected from holding groove 110. Carrying groove 124 is fluidly connected to the flow of purge air through dose piston 86 and shaft bore 104. Carrying groove 124 carries a dose volume of solvent within the carrying groove 124 and between holding groove 110 and dosing groove 112. The solvent within carrying groove 124 is entrained in the airflow through purge air bore 118 and shaft bore 104 and carried downstream by that purge air to mix chamber 30.

Control piston 84 displaces in second axial direction AD2 and shifts to the first control position. Shuttles 62a, 62b are driven in second axial direction AD2 to fluidly disconnect the component material flows from the mix chamber 30 and fluidly connect the purge air flow with the mix chamber 30. The compressed air drives displacement of control piston 84 and dose piston 86 such that both control piston 84 is placed in the first control position and dose piston 86 is placed in the first dope position, as shown in FIG. 5C.

As discussed above, spray lock 88 can be placed in the locked state to maintain control piston 84 in the first control position. With control piston 84 locked in the first control position, dose piston 86 can still be actuated to dose volumes of solvent to mix chamber 30, facilitating thorough cleaning of mix chamber 30.

With control piston 84 locked in the first position, spray applicator 12 can be triggered to cause actuation between the state shown in FIG. 4B and FIG. 5C. Control piston 84 is maintained in the first control position. Trigger 22 is pulled to cause compressed air to be routed to sub-chamber 80a through inlet bores 78a. The compressed air flows through displacement passages 102a and drives dose piston 86 in second axial direction AD2 to the second dose position. Spray lock 88 prevents axial movement of control piston 84. With dose piston 86 in the second dose position, carrying groove 124 is fluidly connected to holding groove 110 to receive solvent.

Spray applicator 12 is detriggered to stop provision of compressed air to sub-chamber 80a and instead direct compressed air to sub-chamber 80b. The compressed air enters sub-chamber through inlet bores 78b. A portion of the compressed air flows through displacement passages 102b and to dose head chamber 100. The compressed air drives dose piston 86 in first axial direction AD1 to the first dose position. The carrying groove 124 is fluidly isolated from holding groove 110 and fluidly connected with dosing groove 112 and portions of shaft bore 104 downstream of dose piston. Compressed air from dose head chamber 100 flows through purge air bore 118 and downstream to entrain the solvent dose and carry the solvent to mix chamber. The user can continue to trigger and detrigger spray applicator 12 to provide additional doses of solvent downstream to mix chamber 30 to clean mix chamber 30.

Spray applicator 12 provides significant advantages. Dose piston 86 provides discrete doses of solvent for entrainment in purge air and transfer to mix chamber 30. Dose piston 86 is carried by and rides within control piston 84, reducing the size of body 20 relative to a configuration in which dose piston 86 is separately carried from control piston 84. Dose piston 86 is disconnected from control piston 84 such that dose piston 86 can move relative to control piston 84 even when control piston 84 is position locked relative to body 20. Dose piston 86 both carries the dose of solvent and defines purge air bore 118 through which purge air is transmitted, simplifying the configuration of the solvent injection into the purge air flow.

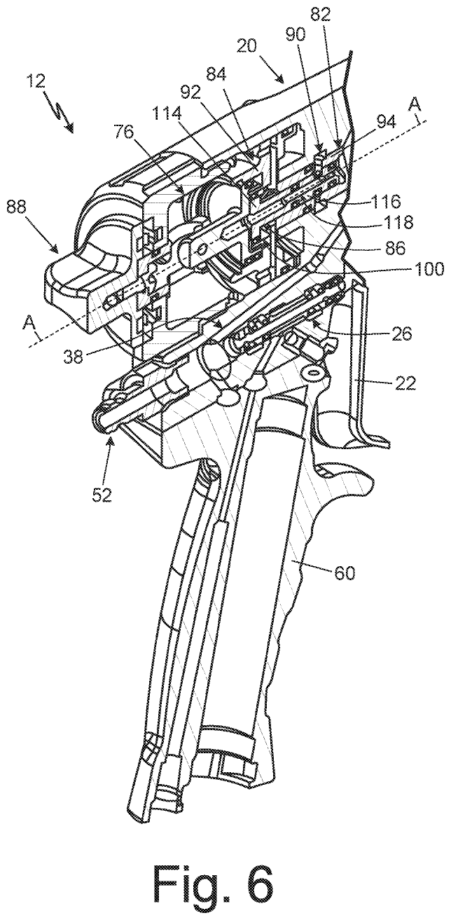

FIG. 6 is an isometric cross-sectional view showing a portion of spray applicator 12. Body 20, control valve 26, handle 60, trigger 22, air fitting 52, control piston 84, dose piston 86, and spray lock 88 of spray applicator 12 are shown. Supply groove 90 and piston bore 82 of body 20 are shown.

Control piston head 92, control piston shaft 94, and shaft seals 96a, 96b of control piston 84 are shown. Control piston head 92 includes axial side 98a, axial side 98b, dose head chamber 100, and displacement passages 102a, 102b (only displacement passages 102a are shown in FIG. 6). Control piston shaft 94 includes shaft bore 104, solvent groove 106, solvent passage 108, holding groove 110, and dosing groove 112. Dose piston head 114, dose piston shaft 116, purge air bore 118, dose head seal 120, and dose seals 122a-122c of dose piston 86 are shown. Dose piston shaft 116 includes carrying groove 124.

Control piston 84 is configured to reciprocate along actuation axis A-A between the first control position associated with emission of purge air and the second control position associated with emission of the plural component material. The control piston 84 is shown in the second control position in FIG. 6. Dose piston 86 is configured to reciprocate between the first dose position associated with dosing solvent into the purge air and the second dose position associated with picking up solvent from the solvent pathway 36. Dose piston 86 is shown in the second dose position in FIG. 6. Dose piston 86 moves relative to control piston 84 between the first dose position and the second dose position.

Control piston 84 is configured to reciprocate along the actuation axis A-A between the first and second control positions. As shown, control piston head 92 includes a cylindrical exterior surface that is disposed within the cylindrical surface of body 20 that defines drive chamber 76. Control piston shaft 94 extends from control piston head 92 and into piston bore 82 within body 20. In the example shown, control piston shaft 94 is cylindrical and piston bore 82 is also cylindrical. Control piston shaft 94 and piston bore 82 are disposed coaxially on actuation axis A-A.

Dose piston 86 is disposed coaxially with control piston 84 on actuation axis A-A. dose piston head 114 is disposed within dosing groove 112 and is configured to reciprocate within dosing groove 112. Dose piston shaft 116 extends axially from dose piston head 114. Dose piston shaft 116 extends into and reciprocates within shaft bore 104 formed within control piston shaft 94. Dose piston shaft 116 is disposed coaxially with control piston shaft 94. Dose piston 86 is disconnected from, but carried by, control piston 84 such that dose piston 86 can move relative to control piston 84.

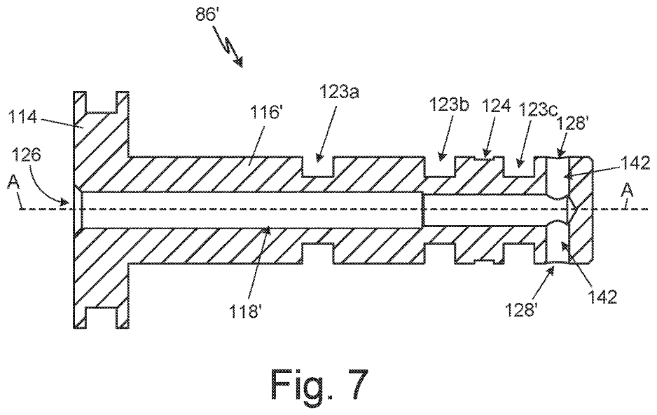

FIG. 7 is a cross-sectional view of dose piston 86′. Dose piston 86′ is substantially similar to dose piston 86, except that dose piston 86′ is configured to output the purge air in a direction away from, rather than along, the axis A-A. Dose piston 86′ includes dose piston head 114, dose piston shaft 116′, purge air bore 118′, and dosing seal grooves 123a-123c. Dose piston shaft 116′ includes carrying groove 124. Purge air bore 118′ includes purge bore inlet 126, purge bore outlet 128′, and outlet bores 142.

Dose piston head 114 is disposed at an axial end of dose piston shaft 116′. Dose piston shaft 116′ extends from dose piston head 114. Dose piston shaft 116′ is configured to extend into shaft bore 104 that is formed within control piston 84. Dose piston shaft 116′ is configured to slide axially within the shaft bore 104 and relative to control piston 84. Dose piston shaft 116′ extends in first axial direction AD1 from dose piston head 114. Dose piston shaft 116′ is configured to ride within shaft bore 104 but is not secured to shaft bore 104 to allow dose piston shaft 116′ to move relative to control piston shaft 94. Dose piston 86′ can interface with control piston shaft 94 within shaft bore 104 such that shaft bore 104 aligns dose piston 86′ for movement along the actuation axis A-A.

Dose seal grooves 123a-123c are formed on dose piston shaft 116′. Dose seal grooves 123a-123c are configured to receive dosing seals 122a-122c, respectively. Dose seal grooves 123a-123c are arrayed along and about dose piston shaft 116′.

Dose seal groove 123a is disposed at a first axial groove location on dose piston shaft 116′. Dose seal groove 123b is disposed at a second axial groove location on dose piston shaft 116′. Dose seal groove 123c is disposed at a third axial groove location on dose piston shaft 116′. The first groove location is disposed axially between dose piston head 114 and the second axial groove location. The second groove location is disposed axially between the first groove location and the third groove location.

Carrying groove 124 is formed on dose piston 86′. Specifically, carrying groove 124 is formed on dose piston shaft 116′. Carrying groove 124 extends radially inward into dose piston shaft 116′. Carrying groove 124 does not extend to or intersect with purge air bore 118′. Carrying groove 124 is formed as a depression in dose piston shaft 116′. Carrying groove 124 is disposed axially between dose seal groove 123b and dose seal groove 123c. Carrying groove 124 can be considered to be axially bracketed by the dose seal grooves 123b, 123c. Carrying groove 124 can be formed as an annular groove that extends fully around dose piston shaft 116′. Carrying groove 124 can extend fully about the actuation axis A-A. Carrying groove 124 is configured to pick up a dose volume of solvent from holding groove 110 and transfer that solvent to dosing groove 112. The solvent is then entrained within the purge air flowing through air pathway 38 (e.g., entrained within second purge air portion through second passage 44) and carried by the purge air to the mix chamber 30.

Purge air bore 118′ extends axially within dose piston 86′. Purge air bore 118′ does not extend fully axially through dose piston 86′ in the example shown. In the example shown, an axial end of dose piston shaft 116′ opposite dose piston head 114 is closed. Purge air bore 118′ extends axially between purge bore inlet 126 to outlet bores 142′ and extends radially to purge air outlet 128′. Purge air bore 118′ defines a purge passage through dose piston 86′ through which purge air flows to entrain the solvent and carry the solvent to mix chamber 30. Purge bore inlet 126 is formed in dose piston head 114. Purge bore inlet 126 is oriented axially in second axial direction AD2. Purge bore outlet 128′ is formed in dose piston shaft 116′. Purge bore outlet 128′ is oriented radially outward away from axis A-A. Purge air bore 118′ forms a portion of the air pathway 38 of spray applicator 12. Purge air bore 118′ is in fluid communication with displacement passages 102b, and thus with sub-chamber 80b. Purge air bore 118′ is configured to receive compressed air from sub-chamber 80b and that compressed air flows through purge air bore 118′ and is output through purge bore outlet 128′ into shaft bore 104.

Outlet bores 142 form a downstream portion of purge air bore 118′ in the example show. The outlet bores 142 extend away from, rather than along, axis A-A. The outlet bores 142 extend radially outward from the axial portion of purge air bore 118′ to an exterior of dose piston shaft 116′. Outlet bores 142 extend between the axial portion of purge air bore 118′ and purge air outlets 128′. Outlet bores 142 extend transverse to the axis A-A. Outlet bores 142 are configured to direct the purge air to a radial exterior of dose piston shaft 116′ rather than through an axial end of dose piston shaft 116′.

In the example shown, outlet bores 142 are formed as a cross-bore through dose piston shaft 116′. The two outlet bores 142 shown are disposed 180-degrees apart on opposite side of axis A-A. It is understood, however, that not all examples are so limited. In the example shown, dose piston 86′ includes multiple purge air outlets 128′. It is understood, however, that not all examples are so limited. For example, dose piston 86′ can include a single purge air outlet 128′, two purge air outlets 128′, three purge air outlets 128′, or any desired number of purge air outlets 128′.

Purge air outlets 128′ are disposed axially between dose seal groove 123c and the axial end of dose piston shaft 116′ opposite dose piston head 114. Purge air outlets 128′ are disposed axially between carrying groove 124 and the axial end of dose piston shaft 116′ opposite dose piston head 114. Purge air outlets 128′ are configured to emit purge air having a radial velocity component as the purge air exits from dose piston 86′. Providing a radial velocity component improves entrainment of the solvent within the purge air, improving purging of the materials from mix chamber 30. The purge air can enter directly into dosing groove 112 and impinge on the surface defining dosing groove 112 as the purge air exits from purge air outlets 128′. In some examples, the purge air is directed orthogonal to the axis A-A. In some examples, outlet bores 142 are canted such that the purge air has both a radial velocity component and an axial velocity component.

In the example shown, purge air bore 118′ is formed by a series of bores that progressively decrease in diameter as purge air bore 118′ extends in first axial direction AD1 and then outlet bore 142′ that extends radially to the exterior of dose piston shaft 116′. Purge bore inlet 126 has a larger diameter than purge bore outlet 128′ in the example shown. The decreasing diameters of purge air bore 118′ increases the velocity of the purge air flowing through purge air bore 118′. Purge bore outlet 128′ being oriented radially encourages impingement of the purge air on the interior surface of the control piston shaft 94 that generates turbulent flow to entrain the solvent within the purge air.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A spray apparatus, the apparatus comprising:
a sprayer body;
a mix chamber supported by the sprayer body;
a purge air pathway extending to an inlet port of the mix chamber to provide purge air to the mix chamber;
a control piston at least partially disposed in the sprayer body, the control piston actuatable along an axis between:
a first control position associated with a purge mode in which the control piston causes component flowpaths to be fluidly disconnected from the mix chamber; and
a second control position associated with a spray mode in which the control piston causes the component flowpaths to fluidly connect to the mix chamber; and
a dose piston at least partially disposed within the sprayer body, the dose piston actuatable between:
a first dose position associated with emission of purge air from the mix chamber, the dose piston configured to provide solvent to the purge air pathway when in the second dose position; and
a second dose position associated with emission of the plural component material from the mix chamber, the dose piston fluidly connected to a solvent passage when in the reset position;
wherein the control piston shifts in a first axial direction along the axis from the first control position to the second control position, the control piston shifts in a second axial direction opposite the first axial direction from the second control position to the first control position, the dose piston shifts in the first axial direction from the second dose position to the first dose position, and the dose piston shifts in the second axial direction from the first dose position to the second dose position.

2. The spray apparatus of claim 1, wherein the dose piston is at least partially disposed within the control piston.

3. The spray apparatus of claim 2, wherein the dose piston is fully disposed within the control piston.

4. The spray apparatus of claim 1, wherein a dose piston head of the dose piston is disposed within a control piston head of the control piston.

5. The spray apparatus of claim 1, wherein the solvent pathway includes at least one passage formed within the control piston.

6. (canceled)

7. The spray apparatus of claim 5, wherein the control piston further comprises:
a solvent groove extending into an exterior surface of the control piston shaft, wherein an inlet of the at least one passage is at least partially disposed in the solvent groove.

8. (canceled)

9. The spray apparatus of claim 1, wherein:
a control piston head of the control piston divides a drive chamber within the sprayer body into a first sub-chamber and a second sub-chamber;
a dose piston head of the dose piston divides a dose head chamber within the spray piston into a dose chamber and a reset chamber;
a first displacement passage is formed through the control piston, the first displacement passage in fluid communication with the first sub-chamber and with the reset chamber;
a second displacement passage is formed through the control piston, the second displacement passage in fluid communication with the second sub-chamber and with the dose chamber.

10. The spray apparatus of claim 9, wherein an inlet of the first displacement passage is formed through a first axial side of the control piston head, and an inlet of the second displacement passage is formed through a second axial side of the spray piston head.

11. (canceled)

12. (canceled)

13. (canceled)

14. The spray apparatus of claim 9, wherein the dose piston includes a dose piston shaft extending axially from the dose piston head, and wherein an end of the dose piston shaft opposite the dose piston head is closed.

15. The spray apparatus of claim 1, further comprising:
a first displacement passage formed through a control piston head of the control piston, the first displacement passage providing motive fluid from a chamber on a first axial side of the control piston head to a chamber on a second axial side of the dose piston head, the first axial side of the control piston head oriented in a first axial direction along the axis, and the second axial side of the dose piston head oriented in a second axial direction along the axis, the first axial direction opposite the first axial direction.

16. The spray apparatus of claim 15, further comprising:
a second displacement passage formed through the control piston head, the second displacement passage providing motive fluid from a chamber on a second axial side of the control piston head to a chamber on the first axial side of the dose piston head, the second axial side of the control piston head oriented in the second axial direction, and the first axial side of the dose piston head oriented in the first axial direction.

17. (canceled)

18. (canceled)

19. (canceled)

20. The spray apparatus of claim 1, wherein:
a control piston shaft of the control piston is at least partially disposed in a piston bore within the sprayer body; and
a dose piston shaft of the dose piston is at least partially disposed in a shaft bore within the control piston shaft.

21. (canceled)

22. (canceled)

23. The spray apparatus of claim 20, wherein a holding groove is formed in a surface of the control piston shaft defining the shaft bore, the holding groove fluidly connected to a solvent source.

24. The spray apparatus of claim 23, further comprising:
a carrying groove formed on an exterior of the dose piston shaft, the carrying groove fluidly connected to the holding groove with the spray apparatus in the spray mode, and the carrying groove fluidly disconnected from the holding groove with the spray apparatus in the purge mode;
wherein the carrying groove is disposed axially between a first dosing seal supported by the dose piston shaft and a second dosing seal supported by the dose piston shaft.

25. (canceled)

26. (canceled)

27. (canceled)

28. The spray apparatus of claim 1, wherein:
the control piston is configured to travel a first distance relative to the spray housing between the first control position and the second control position;
the dose piston is configured to travel a second distance relative to the spray housing between the first dose position and the second dose position; and
first distance is larger than the second distance.

29. The spray apparatus of claim 28, wherein the dose piston is configured to travel a third distance relative to the control piston between the first dose position and the second dose position, the third distance smaller than the first distance and larger than the second distance.

30. The spray apparatus of claim 1, further comprising:
a spray lock interfacing with the control piston, the spray lock actuatable between a locked state, in which the spray lock retains the control piston in the first control position, and an unlocked state, in which the control piston is movable to the second control position;
wherein the dose piston is movable between the first dose position and the second dose position with the spray lock in the locked state.

31. The spray apparatus of claim 1, further comprising:
a trigger supported by the sprayer body, the trigger operatively connected to an air control valve to direct pressurized air to control actuation of the control piston; and
a handle extending from the sprayer body.

32. (canceled)

33. A spray apparatus comprising:
a control piston operatively connected to a spray valve to actuate the spray apparatus between a spray state and a purge state, wherein spray material is emitted from a spray orifice with the spray apparatus in the spray state and purge air is emitted from the spray orifice with the spray apparatus in the purge state; and
a dose piston carried by the control piston and actuatable between a first dose position and a second dose position, wherein the dose piston is configured to pick up a volume of solvent in the second dose position and the dose piston is configured to dose the volume of solvent into the purge air in the first dose position;
wherein the dose piston moves in an opposite direction from the spray piston along an actuation axis as the spray apparatus transitions between the spray state and the purge state.

34. (canceled)

35. (canceled)

36. A method of spraying, the method comprising:
placing a spray applicator in a spray mode, wherein a first material pathway and a second material pathway are fluidly connected to a mix chamber with the spray applicator in the spray mode;
emitting, by the spray applicator, a plural component material formed within the mix chamber by a first base component material provided to the mix chamber through the first material pathway and a second base component material provided to the mix chamber through the second material pathway;
actuating a control piston in a first axial direction along an actuation axis to fluidly disconnect the first material pathway and the second material pathway from the mix chamber and to fluidly connect a purge air pathway with the mix chamber, thereby placing the spray applicator in a purge mode; and
actuating a dose piston in a second axial direction along the actuation axis to entrain dose of solvent picked up from a location within the control piston into a purge air flow flowing axially through the dose piston and the control piston to be carried to the mix chamber by the purge air flow, the second axial direction opposite the first axial direction.

37. (canceled)
